(19) United States
(12) Patent Application Publication
(10) Pub. No.: US 2026/0125559 A1
(43) Pub. Date: May 7, 2026

(54) SINGLE-CRYSTAL METAL-FREE HELICAL COVALENT POLYMERS

(71) Applicant: City University of Hong Kong, Hong Kong (HK)

(72) Inventors: Qichun ZHANG, Hong Kong (HK); Miaomiao XUE, Hong Kong (HK)

(21) Appl. No.: 18/940,757

(22) Filed: Nov. 7, 2024

(51) Int. Cl. C08L 85/02

(52) U.S. Cl. CPC C08L 85/02; C08L 2201/08

(57) ABSTRACT

This invention relates to the development of covalent organic frameworks (COFs) and/or covalent organic polymers (COPs) utilizing tellurium-based dynamic covalent bonds (—Te—O—B— and —Te—O—P—) to create high-quality single crystals with unique properties. This invention also provides concise and efficient methods to grow large single crystals of tellurium-based polymers, overcoming challenges associated with misassembly and poor crystallinity during synthesis. The tellurium-based COFs and COPs exhibit enhanced thermal and solvent stability, making them suitable for applications in catalysis, separation, and energy storage.

### FIELD OF THE INVENTION

The present invention generally relates to the field of covalent organic materials and their applications in optics, photocatalysis, nonlinear optical (NLO) and room-temperature phosphorescence (RTP). It focuses on the development of tellurium-containing polymer crystals, particularly in one-, two-, and three-dimensional forms, to address challenges associated with their synthesis and stability.

### BACKGROUND OF THE INVENTION

Covalent organic frameworks (COFs) are highly versatile materials that have garnered significant interest across various scientific fields. The development of COFs has shown significant potential in fields like catalysis, separation, energy storage, optoelectronics, and biosystems. Traditionally, most COFs have been built using dynamic covalent bonds, such as —C═N—, —B—O—, and —P—O—B—, which allow self-correction during assembly and enable the formation of large single crystals suitable for structural analysis. However, the library of available dynamic covalent bonds remains limited, resulting in challenges in diversifying the structural properties and functionalities of COFs. Additionally, many COFs suffer from poor crystallinity, which limits their use in applications requiring precise structural information, such as advanced catalysis and energy storage.

Recent research has begun to explore the integration of heavy elements, such as tellurium, into COFs to form new types of dynamic covalent bonds. These bonds offer potential advantages, including self-correction during the COF assembly process and enhanced functionality. However, despite these advances, challenges such as improving thermal and solvent stability, as well as achieving specific properties like ultraviolet nonlinear optical (UV-NLO) behavior and photocatalytic efficiency, persist. Moreover, dynamic covalent bonds involving heavy atoms are still not widely utilized, and their impact on important properties like spin-orbit coupling (SOC) and intersystem crossing (ISC) for applications such as RTP remains underexplored.

The preparation of covalent organic polymers (COPs) has also faced limitations, particularly with respect to growing high-quality single crystals that can be used for structural analysis. The ability to produce single crystals from COPs has been restricted by factors such as the poor reversibility of covalent bonds and the inherent challenges associated with stabilizing these materials in the presence of oxygen or under thermal conditions. Moreover, metal-free organic molecules are rarely able to exhibit room-temperature phosphorescence due to the quenching of triplet excitons by oxygen, presenting an additional obstacle in developing new functional materials.

Therefore, there is a continuing need to develop advanced covalent polymers that can overcome these limitations. Improvements in the synthesis and stability of these materials will significantly benefit both academia and industry by enabling more robust applications in fields such as energy storage, catalysis, and optoelectronics.

### SUMMARY OF THE INVENTION

To address the above-mentioned shortcomings, a first aspect of the present invention provides a metal-free helical covalent organic polymer, which includes a helical backbone formed from one or more tellurium atoms covalently bonded to organic phosphonic acid groups, the one or more tellurium atoms form a repeating unit that contributes to a helical structure. The metal-free helical covalent organic polymer exhibits a metal-free composition and a three-dimensional or two-dimensional network arrangement. The metal-free helical covalent organic polymer exhibits a thermal stability at a temperature of at least 300° C.

In accordance with one embodiment, the organic phosphonic acid groups are selected from the group consisting of 1,4-phenylenebis (phosphonic acid), naphthalene-2,6-diylbis (phosphonic acid), and benzene-1,3,5-triyltris (phosphonic acid).

In accordance with one embodiment, the metal-free helical covalent organic polymer has a helical pitch of less than 10 nm.

In accordance with one embodiment, the metal-free helical covalent organic polymer displays photocatalytic activity in oxidation of primary amines to imines under UV-visible light irradiation.

In accordance with one embodiment, the metal-free helical covalent organic polymer forms single crystals with sizes greater than 200 μm.

In accordance with one embodiment, the repeating unit is represented by a structural formula comprising —Te—O—P(═O)— or —Te—O—P— bonds.

In accordance with one embodiment, the —Te—O—P— bonds are formed by incorporating the one or more tellurium atoms and [P═O] groups into the backbone. The incorporation of the one or more tellurium atoms enhances the spin-orbit coupling (SOC) effects, contributing to unique electronic properties.

In accordance with one embodiment, covalent linkages between the one or more tellurium atoms and the organic phosphonic acid groups result in enhanced structural stability.

In accordance with one embodiment, the one or more tellurium atoms improve charge separation during photocatalytic processes, leading to an enhancement in overall photocatalytic performance by at least 25% to 40% compared to conventional polymers.

In another aspect, the present invention provides a metal-free helical covalent organic polymer represented by the formula {[Te(C₆H₅)₂][PO₃(OH)]}ₙ. The helical covalent organic polymer includes a helical structure formed from angular anions incorporated into tellurium-oxygen chains, and phenyl units as side groups. “n” indicates it is a polymer structure, and the metal-free helical covalent organic polymer exhibits thermal stability up to 356° C. with minimal weight loss.

In accordance with one embodiment, the helical structure exhibits a pitch of approximately 17.03 Å.

In accordance with one embodiment, the angular anions are phosphates (PO₄³⁻) and/or their derivatives.

In accordance with one embodiment, the neighboring helical chains are interconnected by hydrogen bonding interactions, forming a pseudo-two-dimensional supramolecular layer structure. The adjacent helical layers exhibit opposite chirality, resulting in a racemic mixture.

In another aspect, the present invention provides a metal-free covalent organic-inorganic hybrid framework, which includes a chiral cubic crystalline structure formed from non-carbon backbones, wherein the chiral cubic crystalline structure comprises a —Te—O—B—O— backbone composed of: (1) tellurium (Te) atoms forming a backbone, the Te atoms are linked by one or more covalent bonds; (2) boron (B) atoms incorporated as nodes within the metal-free covalent organic-inorganic hybrid framework in a form of borate groups; and (3) oxygen (O) atoms facilitating the formation of Te—O and B—O bonds. The metal-free covalent organic-inorganic hybrid framework exhibits UV absorption in a range of 200-300 nm. The metal-free covalent organic-inorganic hybrid framework exhibits a thermal stability with a decomposition temperature of at least 310° C. considering a 5% weight loss.

In accordance with one embodiment, the Te atoms are present in a form of tellurinyldibenzene (Te(Ph)₂) units.

In accordance with one embodiment, the metal-free covalent organic-inorganic hybrid framework exhibits stability when exposed to various solvents and heat. For example, the metal-free covalent organic-inorganic hybrid framework demonstrates stability in common solvents including acetone, dichloromethane, hexane, ethanol, 1,4-dioxane, dimethylformamide, and water.

In accordance with one embodiment, the framework consists of single crystals with dimensions of up to 400 μm.

In accordance with one embodiment, the metal-free covalent organic-inorganic hybrid framework demonstrates a second harmonic generation (SHG) response comparable to that of potassium dihydrogen phosphate (KDP).

### BRIEF DESCRIPTION OF THE DRAWINGS

Embodiments of the invention are described in more details hereinafter with reference to the drawings, in which:

FIG. 1A shows a synthetic route of the metal-free helical covalent inorganic polymer. FIG. 1B shows a helical structure of the metal-free helical covalent inorganic polymer, and the hydrogen atoms are omitted for clarity. FIG. 1C shows optical images for large single crystals of the metal-free helical covalent inorganic polymer with different measuring scales. FIG. 1D shows the scanning electron microscope (SEM) image of the single crystal of the metal-free helical covalent inorganic polymer. FIG. 1E shows the corresponding mapping images of C, O, Te, and P elements;

FIG. 2A shows an asymmetric unit of the helical chain in the metal-free helical covalent inorganic polymer with thermal ellipsoids of 50% probability. FIG. 2B shows two Te(phenyl)₂ nodes linked by the [PO₃(OH)]²− ion through Te—O bonds and formation of a dihedral angle of 65°. FIGS. 2C-2D show a structure and the corresponding non-carbon backbone of a single left-handed chain;

FIG. 3A shows a packing mode of helical chains in the metal-free helical covalent inorganic polymer. FIG. 3B shows a view of the P—O—H . . . O═P hydrogen bond interactions between two neighboring same helical chains;

FIG. 4A shows a 3-D supramolecular structure of the metal-free helical covalent inorganic polymer along the b axis, showing that the helical chain-based 2-D supramolecular layers with opposite helicity are interconnected by Ar—H . . . O—P interactions. FIG. 4B shows a view of the Ar—H . . . O—P hydrogen bond interactions between two helical chains from different 2-D supramolecular layers;

FIG. 5A shows the Fourier transform infrared (FTIR) spectrum of the helical chains in the metal-free helical covalent inorganic polymer. FIG. 5B shows TGA curves of the metal-free helical covalent inorganic polymer;

FIG. 6A shows simulated and experimental PXRD patterns of the metal-free helical covalent inorganic polymer. FIG. 6B shows an asymmetric unit of the single crystal structure with symmetry elements. The white lines represent 2-fold axes, and the planes represent glide planes. The metal-free helical covalent inorganic polymer crystallizes in the non-centrosymmetric space group. FIG. 6C shows optical image under POM with the original interference color and the disappearance of the interference color;

FIG. 7 shows a linkage for COFs with high-quality single crystals and design ideas for the present invention;

FIG. 8A shows the growth of single-crystal COP-1 and COP-2. FIG. 8B shows an optical microscopic image for COP-1;

FIG. 9 shows an asymmetric unit of COP-1. Thermal ellipsoids are drawn at the 50% probability level;

FIG. 10A shows partial enlargement of COP-1 to clarify the connection in the 2D framework. FIG. 10B shows single-crystal structure of COP-1;

FIGS. 11A-11B show host-guest interactions in the structure of COP-1 along b axis and along a axis;

FIG. 12A shows the packing diagram of COP-1. Guest molecules are omitted for clarity.

FIG. 12B shows the packing diagram of COP-1 with guests;

FIG. 13A shows an optical microscopic image for COP-2. FIG. 13B shows an asymmetric unit of COP-2. Thermal ellipsoids are drawn at the 50% probability level;

FIG. 14A shows partial enlargement of COP-2 for clarifying the connection in the 2D framework. FIG. 14B shows a single-crystal structure of COP-2. Hydrogen atoms are omitted for clarity;

FIG. 15 shows growth of single-crystal COP-3 and its optical microscopic image;

FIG. 16A shows the detailed covalent connecting method in COP-3. FIG. 16B shows bowling-shaped macrocycle in the single-crystal structure of COP-3 and its single-crystal structure. FIG. 16C shows the packing diagram between different layers of COP-3. Hydrogen atoms are omitted for clarity;

FIG. 17A shows growth of single-crystal COP-4 and its optical microscopic images.

FIG. 17B shows an asymmetric unit of COP-4. Thermal ellipsoids are drawn at the 50% probability level. FIG. 17C shows the detailed covalent connection of COP-4. FIG. 17D shows simplified diagram for clarifying the covalent connection in single-crystal of COP-4. FIGS. 17E-17G show crystal structures and topological structures of COP-4. Hydrogen atoms are omitted for clarity;

FIG. 18A shows the SEM images and corresponding mapping images of C, O, P, and Te elements for crystals of COP-1 to COP-4. FIG. 18B shows the FTIR spectra of COP-1 to COP-4;

FIGS. 19A-19D show simulated and experimental PXRD patterns of COP-1 to COP-4. The simulated curves are from the SCXRD data simulation. The experiment curves are from PXRD experiments with samples after soaking and washing in dichloromethane, hexane, methanol, 1,4-dioxane, dimethylformamide, water, and ethanol in turn for 30 min and drying;

FIG. 20 shows TGA curves of single-crystal COP1 to COP-4, with T_{d}=340° C., 344° C., 353° C., and 347° C., respectively;

FIG. 21A shows UV-vis spectra of COP1 to COP-4. FIG. 21B shows COP1 to COP-4 catalyzed the aerobic oxidation from amines to imines. FIG. 21C shows photocatalytic performance of COP1 to COP-4. FIG. 21D shows cycle experiment of aerobic oxidation of benzylamine with COP-4 as photocatalyst. FIG. 21E shows photocatalytic performance for COP-4 catalyzed the aerobic oxidation of benzylamine derivatives. FIG. 21F shows electron paramagnetic resonance (EPR) signals of the reaction solution under light irradiation and the dark with DMPO as the spin-trapping reagent. FIG. 21G shows a schematic diagram of the photocatalytic process;

FIG. 22A shows preparation of single crystals of COP-5. FIG. 22B shows the multiple hydrogen bonding interactions between adjacent chains in COP-5;

FIG. 23 shows an asymmetric unit of COP-5. Thermal ellipsoids are drawn at the 50% probability level;

FIG. 24A shows pseudo-2D single-crystal structure of COP-5. FIG. 24B shows simplified hydrogen-bonded Pseudo-2D structure diagram of COP-5. FIG. 24C shows a view of the hydrogen-bonded 2D supramolecular layer structure of COP-5 based on the chains along the b axis. FIG. 24D shows a view of the hydrogen-bonded 2D supramolecular layer structure of COP-5.

FIG. 25A shows an optical microscopic image for single-crystal COP-5. FIG. 25B shows the SEM image and the corresponding mapping images of C, O, P, and Te elements for single crystals of COP-5. FIG. 25C shows the FTIR spectrum of COP-5;

FIG. 26A shows PXRD patterns of COP-5 and the simulated curve from single crystals. FIG. 26B shows the PXRD curves of single crystals of COP-5 immersed in different solvents for 60 hours;

FIG. 27 shows TGA curve of single crystals of COP-5;

FIG. 28 shows UV-vis absorption, fluorescence, and phosphorescence spectra of single crystals of COP-5 at room temperature in the air (λ_{ex, PL.}=330 nm, λ_{ex, Phos.}=350 nm);

FIG. 29 shows phosphorescence decay curves of single crystals of COP-5 at room temperature under ambient conditions (λ_{ex, Phos.}=350 nm);

FIG. 30A shows the photographs of single crystals of COP-5 before and after switching off UV light with 365 nm. FIG. 30B shows the photographs of single crystals of COP-5 treated with/out solvents before and after switching off UV light with 365 nm;

FIG. 31 shows the photographs of single crystals of COP-5 immersed in different solvents with RTP properties;

FIG. 32A shows growth of single-crystal of metal-free covalent organic-inorganic hybrid framework. FIG. 32B shows the optical microscope image of single crystals for single-crystal of metal-free covalent organic-inorganic hybrid framework. FIG. 32C shows an optical microscope image of single crystals for single-crystal of metal-free covalent organic-inorganic hybrid framework in the crude suspension after reaction and before washing with solvents;

FIG. 33A shows an asymmetric unit of single-crystal of metal-free covalent organic-inorganic hybrid framework. Thermal ellipsoids are drawn at the 50% probability level. FIG. 33B shows components of the single-crystal of metal-free covalent organic-inorganic hybrid framework and connection method. FIG. 33C shows a single crystal structure of single-crystal of metal-free covalent organic-inorganic hybrid framework. Hydrogen atoms are omitted for clarity;

FIG. 34A shows Te—O—B backbone of single-crystal of metal-free covalent organic-inorganic hybrid framework. FIG. 34B shows a topology structure of single-crystal of metal-free covalent organic-inorganic hybrid framework. Phenyl groups are omitted for clarity:

FIG. 35A shows a SEM image for the single crystal of single-crystal of metal-free covalent organic-inorganic hybrid framework. FIG. 35B shows the corresponding mapping images of B, C, O, and Te elements. FIG. 35C shows FTIR spectra of the single crystal of single-crystal of metal-free covalent organic-inorganic hybrid framework; and

FIG. 36A shows experimental data for samples after solvent treatment and simulated PXRD patterns of metal-free covalent organic-inorganic hybrid framework. FIG. 36B shows TGA curve of single-crystal of metal-free covalent organic-inorganic hybrid framework. FIG. 36C shows UV-vis absorption spectrum of metal-free covalent organic-inorganic hybrid framework. FIG. 36D shows the SHG response of CityU-22 and KDP.

### DETAILED DESCRIPTION OF THE INVENTION

The present invention will be described in detail through the following embodiments with appending drawings. It should be understood that the specific embodiments are provided for an illustrative purpose only, and should not be interpreted in a limiting manner. Those skilled in the art will appreciate that the invention described herein is susceptible to variations and modifications other than those specifically described.

The invention includes all such variations and modifications. The invention also includes all of the steps and features referred to or indicated in the specification, individually or collectively, and any and all combinations or any two or more of the steps or features. Other aspects and advantages of the invention will be apparent to those skilled in the art from a review of the ensuing description.

Recent breakthroughs in one-/two-/three-dimensional (1D/2D/3D) covalent polymers have been particularly illuminating, especially given the high demand for perfect polymer single crystals due to their attractive properties. In contrast to other main group elements, group VI elements rarely form long polymer main chains. Tellurium, the heaviest element in group VI, has shown promising properties and applications in both inorganic and organic small molecules. However, the formation of tellurium-containing polymer crystals has been challenging. The single crystals of tellurium-based organic polymers are quite rare compared to other main group elements-based organic polymers. Especially, there has been no success of 2D/3D tellurium-based COPs. Additionally, there remain challenges in utilizing single-crystal COPs as photocatalysts.

On the other hand, the application of single-crystal COPs in optics, including NLO and RTP, is uncommon. Second-order NLO materials have been demonstrated to show great importance in photoelectronic fields. Traditionally, the exploration of NLO materials mainly focuses on inorganic systems, among which borates display high NLO performance. Although organic systems have received increasing attention in past decades, their performance is not as good as inorganic systems. In addition, most high-performance inorganic NLO materials are built through ionic bonding, H-bonding or Coulomb interactions, which are not stable under polar solvents and humid environments. In some cases, they are not environmentally friendly due to the existence of heavy metals in their composition.

Accordingly, the present invention provides a series of metal-free covalent polymers, including covalent organic polymers (e.g., COP-1 to COP-5), a metal-free helical covalent inorganic polymer, and a metal-free covalent organic-inorganic hybrid framework.

The metal-free helical covalent polymer is a network formed by covalent linkages between tellurium atoms and organic/inorganic phosphonic acid groups. It exhibits a helical structure, thermal stability at temperatures exceeding 300° C., and photocatalytic properties under UV-visible light. Its backbone includes repeating —Te—O—P(═O)— linkages that enhance electronic properties such as spin-orbit coupling (SOC). The polymer can be synthesized in single crystals larger than 200 μm, useful for photocatalytic applications, notably in oxidation reactions.

The metal-free covalent organic-inorganic hybrid framework features a chiral cubic crystalline structure composed of non-carbon backbones. It includes a —Te—O—B—O— linkage between tellurium and boron atoms, offering UV absorption within the 200-300 nm range. The framework demonstrates excellent stability in common solvents and thermal conditions. It forms large single crystals, up to 400 μm, and can be applied in nonlinear optical (NLO) and photocatalytic fields due to its stable framework.

Each of COP-1 to COP-5 displays unique structural and photocatalytic properties, characterized by tellurium-oxygen-phosphorus (Te—O—P) linkages: COP-1 consists of a two-dimensional hexagonal network, where each phosphonic acid group is linked to tellurium atoms. COP-2 is a rectangular crystal network based on naphthalene-2,6-diylbis(phosphonic acid) and tellurinyldibenzene, forming a two-dimensional layered structure. COP-3 is a two-dimensional hexagonal network based on benzene-1,3,5-triyltris(phosphonic acid) and tellurinyldibenzene. COP-4 is a three-dimensional framework with a larger organic ligand (1,3,5-tris(4-phosphonophenyl)benzene) connected to tellurinyldibenzene, forming a highly interpenetrated network. COP-5 is a hydrogen-bonded pseudo-2D structure with excellent room-temperature phosphorescence (RTP) due to its incorporation of tellurium and phosphonate groups. Exhibits solvent stability and long phosphorescence lifetimes.

Moreover, the present invention also provides synthesis processes for growing large single crystals for 1D/2D/3D tellurium-based covalent polymers.

The method for synthesizing a metal-free covalent organic polymer includes mixing organic phosphonic acid compounds with tellurium precursors in a solvent to form a reaction mixture; heating the reaction mixture at a temperature ranging from 100-120° C. to facilitate the formation of covalent linkages between the organic phosphonic acid groups and tellurium atoms; and cooling the resulting polymer solution and collecting the metal-free helical covalent organic polymer.

In an embodiment, the step of collecting the metal-free covalent organic polymer includes collecting the precipitate through filtration.

In an embodiment, the method further includes washing with a suitable solvent to remove unreacted materials; and drying the collected polymer under vacuum at a temperature of 30-60° C. to obtain the final metal-free covalent organic polymer.

A method for synthesizing the metal-free helical covalent inorganic polymer includes synthesizing a monomer by combining tellurium and a phenyl-substituted compound to form tellurinyldibenzene; combining the tellurinyldibenzene, an aqueous solution of polyphosphoric acid, and a solvent to obtain a reaction mixture; ultrasonically mixing the reaction mixture to ensure thorough mixing of components; cooling the reaction mixture by freezing in a liquid nitrogen bath; evacuating and refilling a glass ampoule containing the reaction mixture with nitrogen gas to create an inert atmosphere; and heating a sealed ampoule at a temperature of 110° C. to 130° C. for a period of 70 to 80 hours to form the metal-free helical covalent inorganic polymer.

In an embodiment, the solvent is selected from 1,4-dioxane or similar organic solvents.

In an embodiment, the method further includes sealing the glass ampoule under vacuum to maintain the reaction environment.

In an embodiment, the reaction mixture is sonicated for a duration of 2 to 5 minutes to enhance homogeneity.

In an embodiment, the freezing step is conducted at temperatures below −196° C. to optimize the reaction conditions.

In an embodiment, the nitrogen gas is refilled in the ampoule three times to ensure complete removal of oxygen.

In an embodiment, the washing step includes a sequential treatment with organic solvents followed by rinsing with deionized water to ensure purity.

In an embodiment, the heating step is conducted in a controlled atmosphere to prevent oxidation of the tellurium component.

A method for synthesizing the metal-free covalent organic-inorganic hybrid framework includes dissolving a predetermined amount of tellurinyldibenzene and boric acid in a solvent mixture to obtain a first solution; heating the first solution at a temperature of 100° C.; and forming crystals and collecting the metal-free covalent organic-inorganic hybrid framework through filtration and subsequent washing.

In an embodiment, the solvent mixture includes a solvent mixture of absolute ethanol and deionized water.

In an embodiment, the weight ratio of tellurinyldibenzene to boric acid is 3:2.

Moreover, the present invention also demonstrates its potential applications as optical materials, including NLO substances, RTP materials, and photocatalysts for the coupling of (arylmethyl)amines mediated by superoxide anion radicals.

Different from most commercial NLO materials, the present invention displays good stability under the treatment of different common solvents or heat. Meanwhile, the material with the UV-Vis absorption range of 200-300 nm exhibits a high second harmonic generation (SHG) response comparable to that of a typical commercial material KH₂PO₄.

The following examples illustrate the present invention and are not intended to limit the same.

### EXAMPLE

### Example 1

### Materials and Methods

All starting chemicals are commercially available and used without further purification.

All the chemicals are purchased from J&K. All solvents are purchased from Anaqua (Hong Kong) Company Limited and used as received. NMR spectra are conducted on the Bruker Avance-400 spectrometers (400 MHz for ¹H, 101 MHz for ¹³C). Chemical shifts (δ) are reported in parts per million (ppm) with TMS as an internal standard. The following abbreviations are used to describe peak splitting patterns: s=singlet, d=doublet, t=triplet, q=quartet, m=multiplet. Single-crystal X-ray diffraction (SCXRD) characterization is performed on the Rigaku X-ray Single Crystal Diffractometer System (Rigaku SmartLab 9 kW-Advance) at 150 K or 293 K. Powder X-ray diffraction (PXRD) data are collected in the reflection mode on a Philips X'Pert diffractometer with a CPS 180 detector using monochromated Cu-Kα (λ=1.5418 Å) radiation or Rigaku X-ray Diffractometer Smatlab™ 9 kW at room temperature. The FTIR spectra in the range of 4,000-400 cm⁻¹ are measured on a Perkin Elmer Spectrum II. The optical images of crystals are taken by the Zeiss microscope. Scanning electron microscope (SEM) and elemental mappings are conducted on Thermo Fisher Quattro S Environmental SEM, among which the signal of mapping for B elements is accumulated twice while the other elements are scanned once. Thermal gravimetric analyses (TGA) are characterized on a Perkin-Elmer Simultaneous Thermal Analyzer STA 6000 under nitrogen flow (20 mL/min) with a heating rate of 10° C. min⁻¹. UV-vis spectra in the range of 200-800 nm are collected by the Hitachi UH4150 UV-VIS-NIR Spectrophotometer. The topological analysis is carried out on the TOPOS program. The EPR spectra are recorded on a Bruker EMXnano spectrometer. The product of the photocatalytic oxidation reaction is detected and analyzed via gas chromatography (with mode GC, 8890, Agilent). The second harmonic generation (SHG) measurements are made on a Q-switched Nd: YAG laser at the wavelength of 1064 nm. The intensity of the frequency-doubled output emitted from samples is collected by a photomultiplier tube. Crystalline KH₂PO₄(KDP) with a similar size as samples are used as references.

### Photocatalysis Measurement

10 mg of a photocatalyst (COP-1 to COP-4) and 3 mL CH₃CN (GR) are placed in a 50 mL quartz tube, and the mixture is degassed with high pure N₂/O₂ (>99.995%, a flow rate of 0.1 L/min) for 5 min. Then, 0.1 mmol of benzylamine is quickly added to the tube under the gas flow. A 300 W Xenon lamp with the light intensity of 200 mW cm⁻² and wavelength range of 320-780 nm is used as the light source. The cooling water circulation is used to maintain the reaction temperature at 298 K. After reaction, the solution is centrifuged and filtered via a syringe filter to remove catalyst particles. For photocatalytic cycle measurements, photocatalysts are centrifuged, filtered, recollected, and washed with CH₃CN after every reaction and before the next test.

### Example 2

### Synthesis of 3D Metal-Free Helical Covalent Inorganic Polymer

It remains challenging to prepare artificial helical polymers. Especially, precisely understanding the structure information of artificial metal-free helical covalent inorganic polymers via SCXRD analysis is rarely explored.

This example prepares a novel metal-free helical covalent inorganic polymer ({[Te(C₆H₅)₂][PO₃(OH)]}n) by introducing angular anions (HOPO₃²⁻) into traditional tellurium-oxygen chains. The dynamic reversibility of the reaction is realized through the introduction of organic tellurium precursor and the slow hydrolysis of polyphosphoric acid. The structure contains —O—Te—O—P— building blocks as the inorganic backbone and phenyl units as side groups.

The metal-free helical covalent inorganic polymer is prepared from achiral monomers via simultaneous crystallization and polymerization. First, a key monomer, tellurinyldibenzene, is synthesized as follows: ¹H NMR (400 MHz, d₄-MeOH): δ (ppm) 7.56-7.61 (m, 6H), 7.89-7.92 (m, 4H); ¹³C NMR (400 MHz, d₄-MeOH): δ (ppm) 134.7, 132.3, 130.9, 129.3.

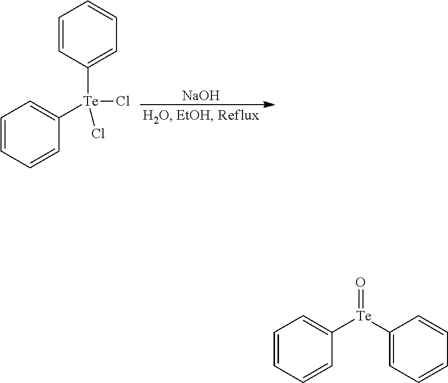

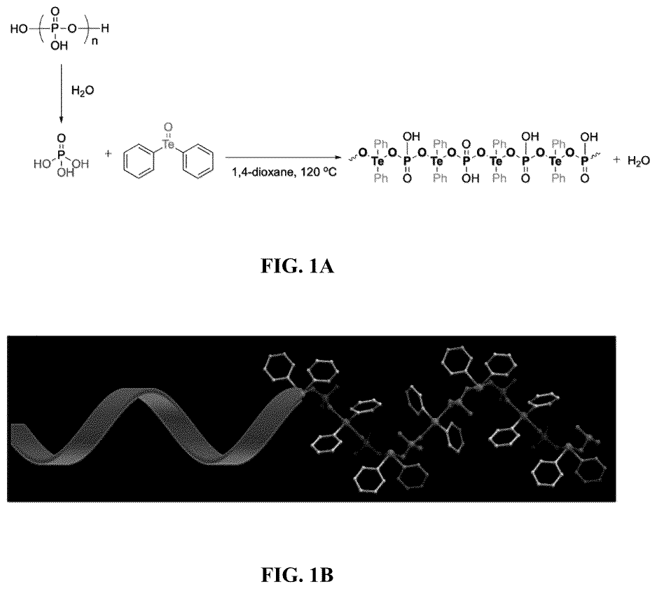

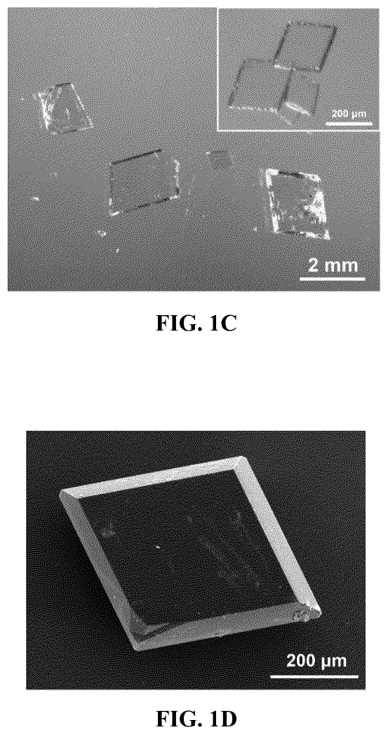

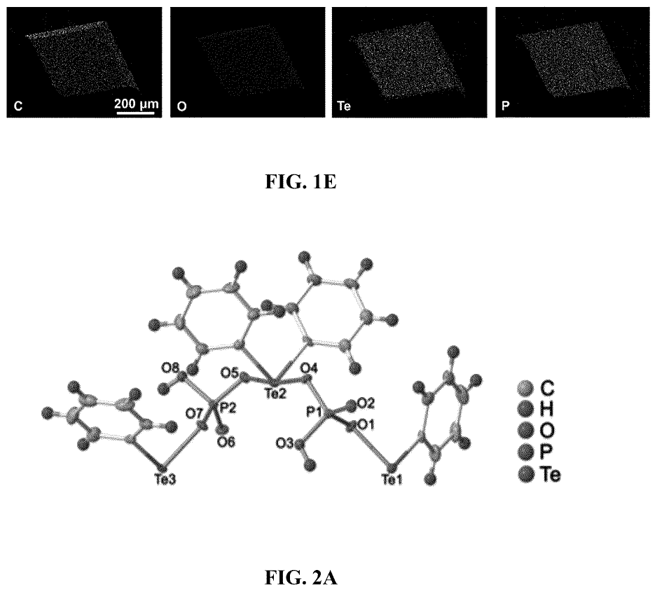

After that, 12.5 mg, 0.0420 mmol of tellurinyldibenzene, 125 μL of polyphosphoric acid aqueous solution (1.00 g polyphosphoric acid in 3.00 mL of deionized water), and 1.00 mL of 1,4-dioxane are added to a glass ampoule. The mixture is ultrasonicated for 3 mins. Then, the glass ampoule is frozen in a liquid nitrogen bath, evacuated and refilled with nitrogen gas three times, and finally sealed under vacuum. After heating at 120° C. for 72 h, large-size colorless crystals are formed in the bottom of the glass ampoule (FIGS. 1A-1B). The crystals are collected through filtration, and washed with 1,4-dioxane, methanol, dimethylformamide, deionized water, and ethanol before dried under vacuum to afford colorless 3D metal-free helical covalent inorganic polymer (8.00 mg, 64%).

### Characterization

The as-obtained crystals have been employed for several measurements, including EDX mapping analysis, SEM, PXRD, FTIR, TGA, and optical microscopy. The single crystals for the SCXRD measurement are obtained from a crude suspension.

The slow hydrolyzation of polyphosphoric acid to phosphoric acid is key to yielding large, colorless, and rhomboid crystals of the 3D metal-free helical covalent inorganic polymer, whose crystal size even reached the millimeter level (FIGS. 1C-1D).

The EDX mapping results confirm that the 3D metal-free helical covalent inorganic polymer contains tellurium, oxygen, phosphorus, and carbon elements (FIG. 1E).

High-quality and large-size single crystals of the 3D metal-free helical covalent inorganic polymer have been successfully characterized via SCXRD, where the same-handed helical inorganic polymer chains form a pseudo-2D layer via multiple hydrogen-bonding interactions. In the structure, the same-handed helical chains (either left- or right-handed) interact with each other via either strong hydrogen bonds (O—H . . . O═P) or weak hydrogen bonds (Ar—H . . . O═P) to form pseudo 2D layers. The left-handed layers and right-handed layers alternatively stack together through weak hydrogen bonds (Ar—H . . . OH) to form a 3D supramolecular structure.

As shown in Table 1, the small R-value (2.52%) of the 3D metal-free helical covalent inorganic polymer can allow to precisely understand atomic positions, bond lengths and angles, polymer helicity, macromolecular interactions, and packing modes.

TABLE 1
Crystal data and structure refinement for the 3D
metal-free helical covalent inorganic polymer

| | 3D metal-free helical |
|---|---|
| | covalent inorganic polymer |
| Empirical formula | C₂₄H₂₂O₈P₂Te₂ |
| Formula weight | 755.55 |
| Temperature / K | 150(2) |
| Crystal system | orthorhombic |
| Space group | Aea2 |
| a / Å | 24.4583(3) |
| b / Å | 17.0280(2) |
| c / Å | 12.61860(10) |
| α/° | 90 |
| β/° | 90 |
| γ/° | 90 |
| Volume / Å³ | 5255.34(10) |
| Z | 8 |
| ρ_{calc} / g · cm⁻³ | 1.910 |
| μ/ mm⁻¹ | 19.084 |
| F(000) | 2912.0 |
| Reflections collected | 9816 |
| Independent reflections | 3881 [Rᵢₙₜ = 0.0276] |
| Data / Restraints / Parameters | 3881 / 1 / 328 |
| Goodness-of-fit on F² | 1.028 |
| Final R indexes [I ≥ 2σ(I)]^{a} | R₁ = 0.0252, |
| | wR₂ = 0.0650 |
| Final R indexes [all data]^{b} | R₁ = 0.0257, |
| | wR₂ = 0.0654 |
| Largest diff. peak and hole / e · Å⁻³ | 0.98 and −0.71 |

^{a}R₁ = Σ||Fₒ| − [F_{c}||/Σ|Fₒ|,
^{b}wR₂ = [Σw(Fₒ² − F_{c}²)²/Σw(Fₒ²)²]^{1/2}

In Table 1, the 3D metal-free helical covalent inorganic polymer crystallizes in the orthorhombic space group Aea2 (old symbol Aba2, No. 41) with lattice parameters of a=24.4583(3) Å, b=17.0280(2) Å and c=12.61860(10) Å.

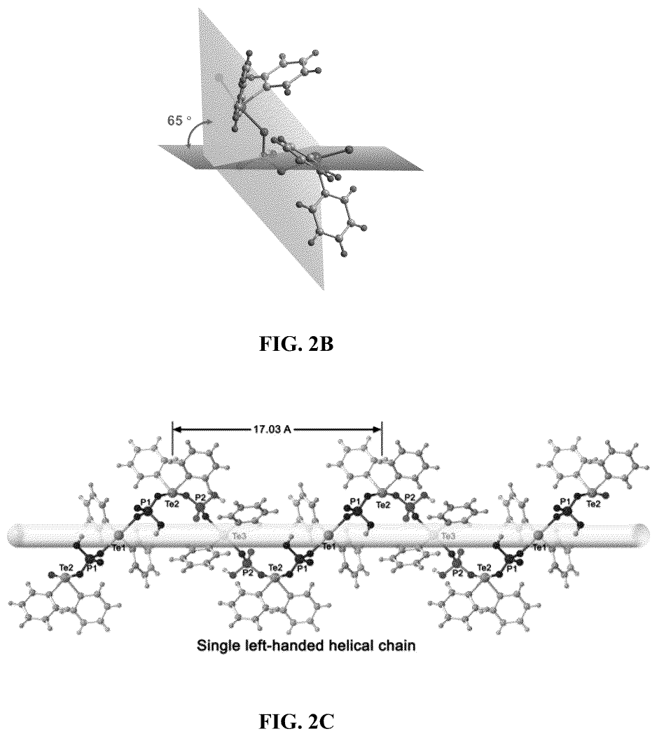

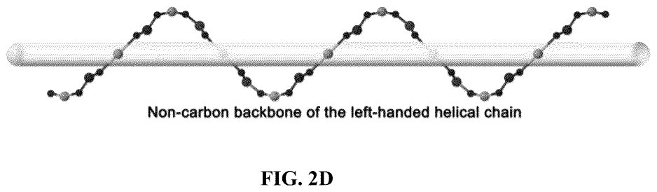

Referring to FIG. 2A, the asymmetric unit contains three crystallographic independent Te(phenyl)₂ units (site occupancy factors of Te1, Te2, and Te3 are 0.5, 1.0, and 0.5, respectively) and two monoprotonated phosphate [PO₃(OH)]²⁻ ions. The position of H atom in the two PO₃(OH) units is determined according to the different bond lengths between HO—P (1.560 and 1.561 Å) and O═P (1.484 and 1.490 Å), as shown in Table 2. In the structure, two Te(phenyl)₂ and one [PO₃(OH)]²⁻ ion form a twisted configuration with a dihedral angle of 65° due to the angle (106°) of (Te—)O—P—O(—Te) in the [PO₃(OH)]²⁻ ion (FIG. 2B and Table 3).

TABLE 2
Selected bond distances (Å) for the 3D
metal-free helical covalent inorganic polymer

| | Atom2 | Å | Atom1 | Atom2 | Å |
|---|---|---|---|---|---|
| Te1 | O1 | 2.124(4) | Te3 | C19² | 2.106(6) |
| Te1 | O1¹ | 2.124(4) | Te3 | C19 | 2.106(6) |
| Te1 | C1 | 2.111(6) | P1 | O1 | 1.566(5) |
| Te1 | C1¹ | 2.111(6) | P1 | O2 | 1.489(5) |
| Te2 | O4 | 2.120(5) | P1 | O3 | 1.560(4) |
| Te2 | O5 | 2.110(4) | P1 | O4 | 1.550(4) |
| Te2 | C7 | 2.114(6) | P2 | O5 | 1.544(4) |
| Te2 | C13 | 2.109(6) | P2 | O6 | 1.485(4) |
| Te3 | O7 | 2.131(4) | P2 | O7 | 1.557(4) |
| Te3 | O7² | 2.131(4) | P2 | O8 | 1.561(4) |

¹1 − X, 2 − Y, +Z;
²1 − X, 1 − Y, +Z

TABLE 3
Selected bond distances (Å) for the 3D
metal-free helical covalent inorganic polymer

| Atom1 | Atom2 | Atom3 | Angel (°) | Atom1 | Atom2 | Atom3 | Angel (°) |
|---|---|---|---|---|---|---|---|
| O1¹ | Te1 | O1 | 169.1(3) | C13 | Te2 | O5 | 89.2(2) |
| C1 | Te1 | O1 | 85.52(19) | C13 | Te2 | C7 | 94.7(2) |
| C1¹ | Te1 | O1¹ | 85.52(19) | C19 | Te3 | O7 | 89.51(19) |
| C1 | Te1 | O1¹ | 87.27(19) | C19 | Te3 | C19² | 96.6(3) |
| C1¹ | Te1 | O1 | 87.27(19) | C19 | Te3 | O7² | 85.36(19) |
| C1¹ | Te1 | C1 | 97.4(3) | C19² | Te3 | O7 | 85.36(19) |
| O5 | Te2 | O4 | 169.99(13) | C19² | Te3 | O7² | 89.51(19) |
| O5 | Te2 | C7 | 84.8(2) | O7 | Te3 | O7² | 172.3(2) |
| C7 | Te2 | O4 | 86.8(2) | O1 | P1 | O4 | 106.1(3) |
| C13 | Te2 | O4 | 86.1(2) | O5 | P2 | O7 | 106.0(2) |

¹1 − X, 2 − Y, +Z;
²1 − X, 1 − Y, +Z

Meanwhile, three Te(phenyl)₂ units are alternatively connected by two independent [PO₃(OH)]²⁻ ions to produce a single helical ICP chain with a helical pitch of 17.03 Å (FIGS. 2C-2D). Notably, this is a first non-carbon helical inorganic backbone constituted from repetitive O—P—O—Te—O moieties.

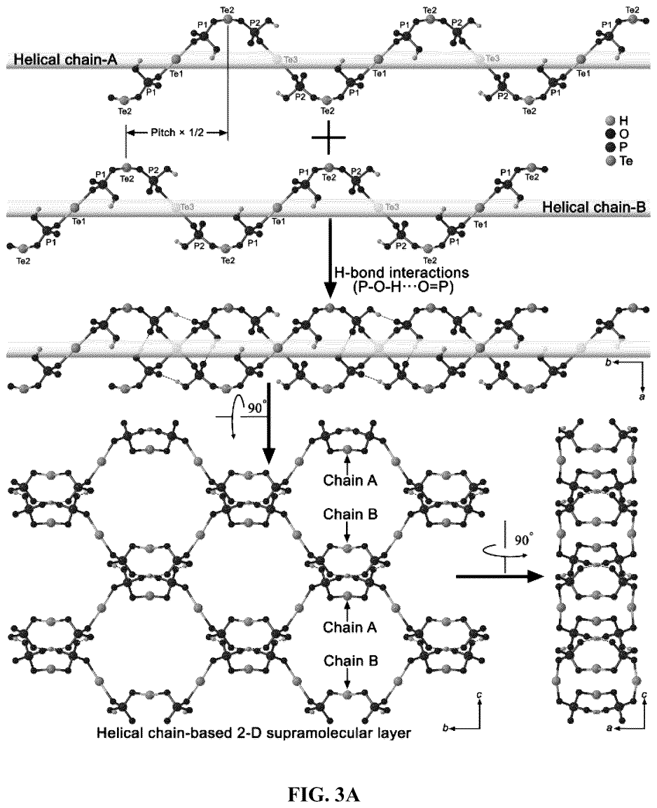

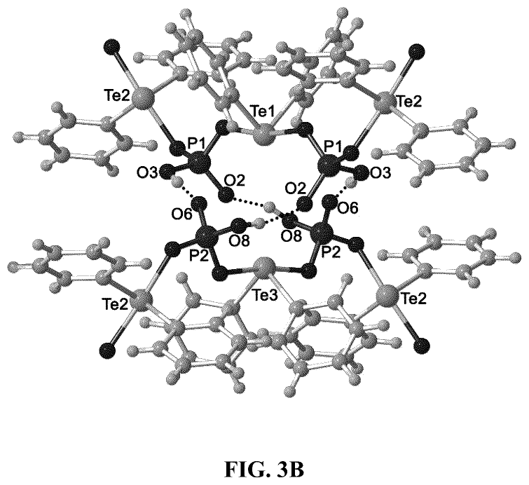

Referring to FIGS. 3A-3B, multiple hydrogen-bonding interactions can be found to exist between the neighboring chains with the same helicity. The neighboring two same helical chains are stacked in parallel along the b axis and one chain is slid by half of a pitch to the other chain. Each of the two Te[PO₃(OH)]₂ motifs from two adjacent chains generates a “dimer” through tight hydrogen-bonding interactions. The unreacted OH groups of one polymer chain interact with the P═O units in the adjacent polymer chains to form two groups of strong hydrogen-bonding interactions (O—H . . . O═P distances of 1.68 and 1.72 Å). There are, in addition, hydrogen-bonding interactions (Ar—H . . . O═P distance of 2.52 Å) between the chains to further stabilize the helical chain. Statistically, there are three oxygens of two PO₃(OH) groups as hydrogen-bond acceptors, two OH groups from two PO₃(OH) groups, and one Ar—H from the phenyl group as hydrogen-bond donors provided in each repeating unit. These interlaced hydrogen-bonding interactions between -ABAB- stacked polymer chains make them contact with each other into a stable pseudo-two-dimensional (2D) supramolecular layer structure, as shown in FIG. 3A.

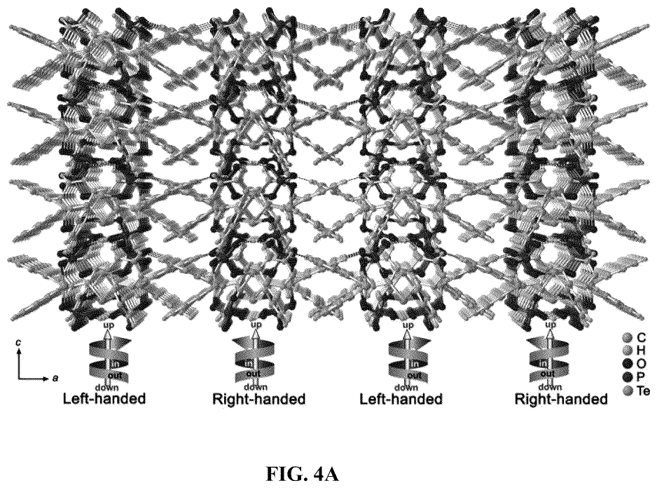

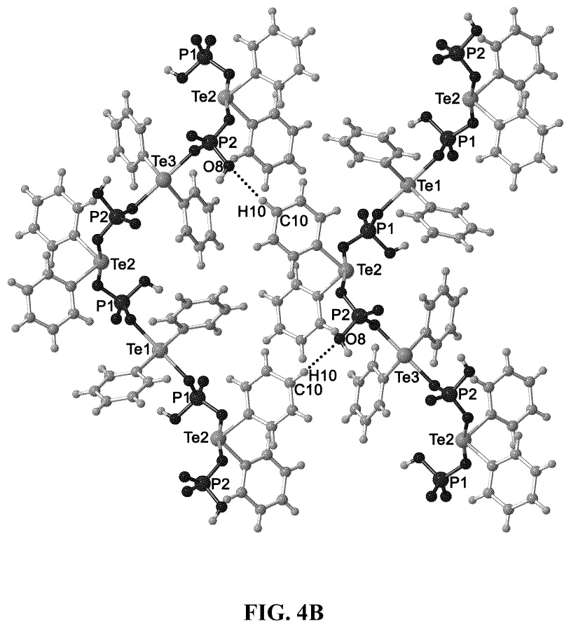

Interestingly, the helical direction of the chains in adjacent layers is opposite with the same structure compositions (FIG. 4A). There exist weak hydrogen-bonding interactions (Ar—H . . . OH distance of 2.48 Å, FIG. 4B), which connect the pseudo-layers into a three-dimensional supramolecular structure. In a unit cell, the number of chains with left-handed or right-handed helicity is the same (3 chains). Thus, the single crystals of the 3D metal-free helical covalent inorganic polymer are racemic.

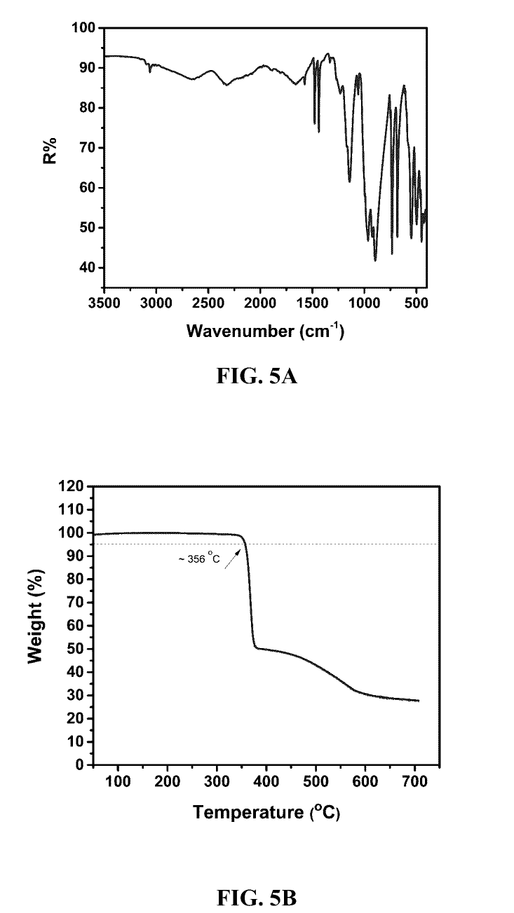

As shown in FIG. 5A, the FTIR results show that the peaks in the range of 750-500 cm⁻¹ and 780-1030 cm⁻¹ come from the stretching of Te—O bonds and P—O bonds. The peak at approximately 1157 cm⁻¹ can be assigned to the P═O vibration, while the peaks at approximately 2300 cm⁻¹ and 2654 cm⁻¹ are contributed from the vibration of the P—O—H unit and the wide peak at approximately 1667 cm⁻¹ is from hydrogen bonds, confirming the existence of hydrogen bonds in the 3D metal-free helical covalent inorganic polymer.

Besides, the 3D metal-free helical covalent inorganic polymer is also examined by TGA. The result indicates that the polymer is thermally stable up to 356° C. with a 5% weight loss (FIG. 5B). Clearly, the combination of the inorganic backbone and organic side groups is the key to providing the high stability.

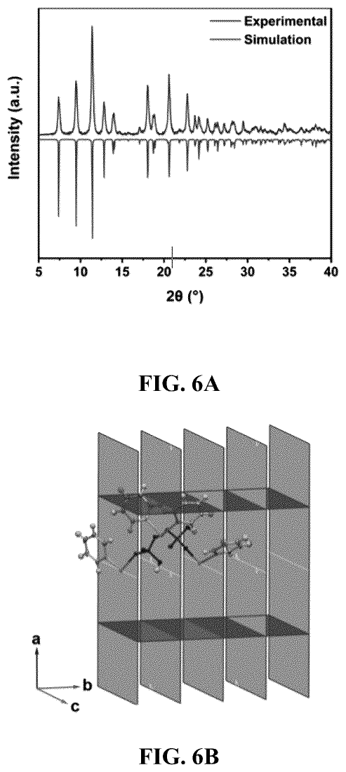

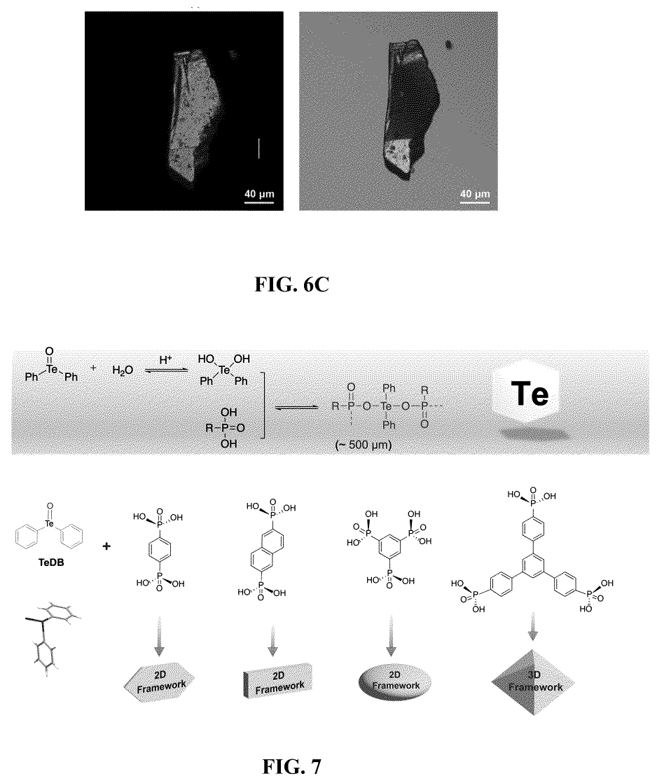

PXRD characterization is carried out to confirm the purity of the 3D metal-free helical covalent inorganic polymer. As shown in FIG. 6A, the experimental powder XRD data match very well with the simulated diffraction pattern from the SCXRD data, proving the high phase purity. The first four diffraction peaks at 7.35°, 9.48°, 11.36°, and 12.82°, can be attributed to (2 0 0), (1 1 1), (2 1 1), and (2 2 0) facets, respectively. The element analysis via EDX mapping measurement and the phase purity analysis by PXRD measurement not only confirm the structure of single crystals but also suggest the high purity of the as-obtained crystals.

To test the stability of the 3D metal-free helical covalent inorganic polymer in solvents, the crystals are treated with common solvents (such as hexane, dichloromethane, ethanol, methanol, acetone, 1,4-dioxane, dimethylformamide, and water), and no changes are found after 10 days based on the PXRD analysis in FIG. 6A.

### Application

Referring to FIG. 6B, the 3D metal-free helical covalent inorganic polymer crystallizes in the non-centrosymmetric orthorhombic space group of Aea2, indicating that it might have interesting optical properties because crystals with orthorhombic symmetry are optically anisotropic and can produce birefringence. Thus, the birefringence is measured using polarized optical microscopy (POM) (Nikon ECLIPSE LV100N POL) equipped with a Berek compensator.

The wavelength of the light source is λ=550 nm. In order to improve the accuracy of the birefringence, the large-sized crystals of the 3D metal-free helical covalent inorganic polymer are pressed and cut into small pieces for measurement. The formula for calculating the birefringence is as follows:

$$R = \vert {n}_{e} - {n}_{o} \vert \times d = Δ n \times d ,$$

R, Δn, and d represent the optical path difference, the birefringence, and the thickness of the tested crystal, respectively.

As shown in FIG. 6C, the crystals of the 3D metal-free helical covalent inorganic polymer possess obvious birefringent phenomena. It displays promising optical properties with a large birefringence of 0.133@550 nm, which is an order of magnitude larger than that of single crystals of previously reported polymers. Such a large birefringence can be attributed to the hydrogen-bonding interactions among polymer chains and layers as well as the function of the Te—O—P backbone.

### Example 3

### Synthesis of Metal-Free Helical COPs

Building on the previous success in obtaining chiral inorganic covalent polymers through the reaction between tellurinyldibenzene and H₃PO₄, this example aims to explore the potential for preparing COPs single crystals by replacing H₃PO₄ with organic phosphonic acids. These COPs have been demonstrated as excellent photocatalysts for superoxide anion-mediated coupling of arylmethyl amines.

First, a critical monomer, tellurinyldibenzene is synthesized as follows: ¹H NMR (400 MHz, d₄-MeOH): δ (ppm) 7.55-7.62 (m, 6H), 7.88-7.93 (m, 4H); ¹³C NMR (400 MHz, d₄-MeOH): δ (ppm) 134.7, 132.3, 130.9, 129.3.

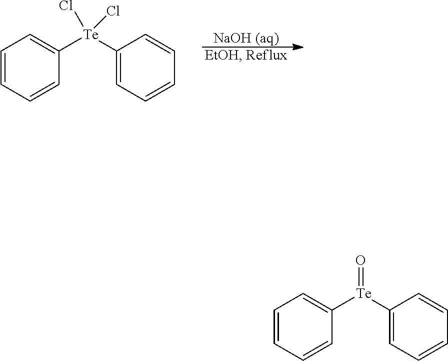

By reacting tellurinyldibenzene with four different organic phosphonic acids, three 2D COP single crystals and one 3D COP single crystals are obtained in two days (FIG. 7).

### Synthesis of 2D COP-1

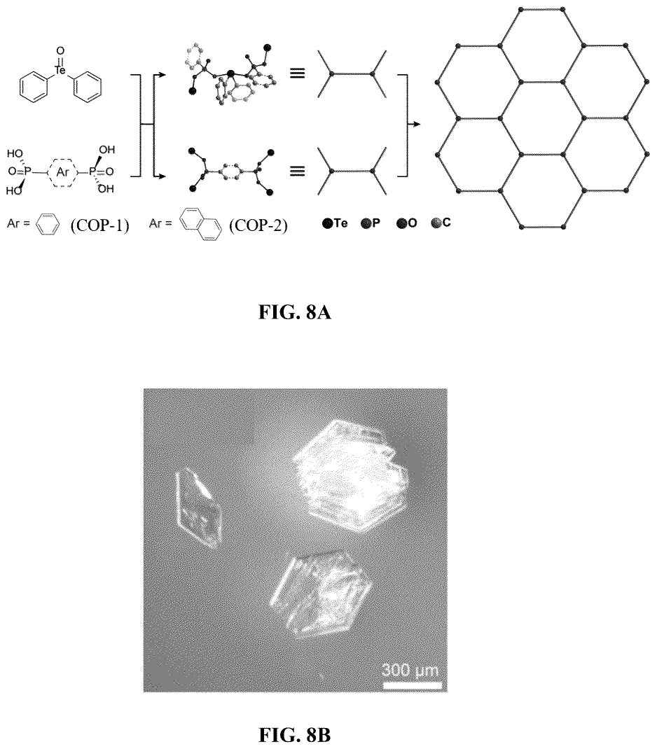

15.0 mg, 0.05 mmol of tellurinyldibenzene, 5.0 mg, 0.021 mmol of 1,4-phenylenebis (phosphonic acid) and 100 μL acetic acid are dissolved in a mixture solvent containing 0.7 ml of absolute ethanol and 0.2 mL of 1,4-dioxane. After ultrasonicated for 3 minutes, the glass ampoule is frozen in an aqueous liquid nitrogen bath and evacuated three times before being sealed under a vacuum atmosphere. After heating at 100° C. for 2 days, large-sized colorless crystals are formed in the glass ampoule. Then, the glass ampoule is cooled to room temperature, and crystals are collected through filtration. These crystals are further soaked in and washed with dichloromethane, hexane, methanol, 1,4-dioxane, dimethylformamide, deionized water, and ethanol in turn. After dried under a vacuum, COP-1 crystals are obtained, yielding 15.5 mg, which corresponds to a yield of 77.5% (FIGS. 8A-8B).

### Synthesis of 2D COP-2

15.0 mg, 0.05 mmol of tellurinyldibenzene, 6.0 mg, 0.021 mmol of naphthalene-2,6-diylbis (phosphonic acid) and 100 μL acetic acid are dissolved in a mixture solvent of 0.7 ml of absolute ethanol and 0.2 mL of 1,4-dioxane. Following the similar procedure to that of COP-1, COP-2 is obtained, yielding 12.5 mg, which corresponds to a yield of 59.5%.

### Synthesis of 2D COP-3

12.5 mg, 0.042 mmol of tellurinyldibenzene, 4.4 mg, 0.014 mmol of benzene-1,3,5-triyltris (phosphonic acid) and 150 μL acetic acid are dissolved in a mixture solvent of 0.7 ml of absolute ethanol and 0.2 mL of 1,4-dioxane. Following the similar procedure to that of COP-1, COP-3 is obtained, yielding 11.0 mg, which corresponds to a yield of 65.0%.

### Synthesis of 3D COP-4

12.5 mg, 0.042 mmol of tellurinyldibenzene, 7.3 mg, 0.014 mmol of 1,3,5-tris (4-phosphonophenyl) benzene and 150 μL acetic acid are dissolved in a mixture solvent of 0.7 ml of absolute ethanol and 0.2 mL of 1,4-dioxane. Following the similar procedure to that of COP-1, COP-4 is obtained, yielding 12.8 mg, which corresponds to a yield of 64.6%.

The solvent-treated, washed, and dried crystals are further used for measurements of PXRD, FTIR, TGA, UV-Vis, EPR, and photocatalyst properties. These high-quality and large-sized crystals (up to 500 μm) allow the data collection with SCXRD (the resolution up to 0.83 Å) to uncover their accurate and detailed structure information. The optical microscopy, SEM, and mapping are carried out with a crude suspension after gentle sonication and solution replacement with ethanol.

### Characterization

The crystal structures for COP-1 to COP-4 are solved and refined by full-matrix least-squares methods against F² with the SHELXL-2014 program package and Olex-2 software.

The SCXRD analysis with a resolution up to 0.83 Å discloses that COP-1 is a 2D metal-free helical covalent organic polymer with repetitive linkages (—Te—O—P(═O)—). The space group of COP-1 is P2₁/c with an asymmetric unit containing four Te(phenyl)₂ units, two 1,4-phenyl (PO₃)₂ moieties, and three guest molecules (one monomer 1,4-phenylenebis (phosphonic acid) and two solvent molecules ethanol, FIG. 9 and Tables 4-6).

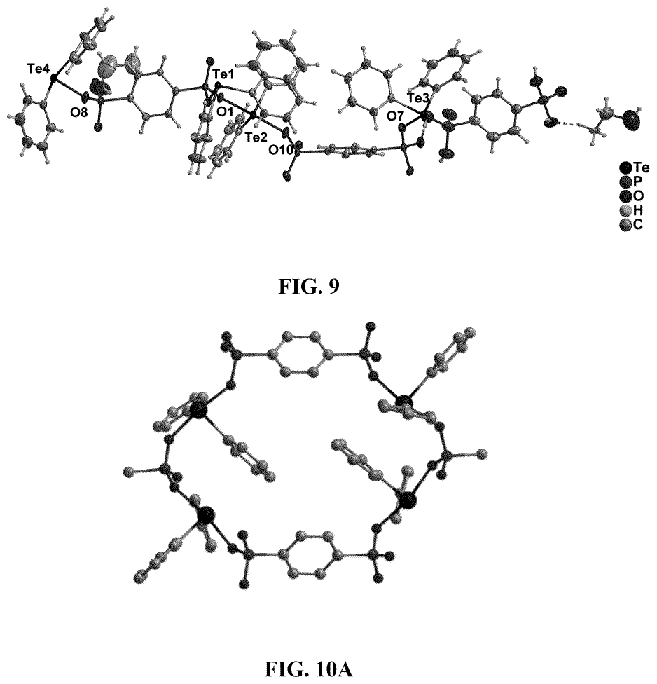

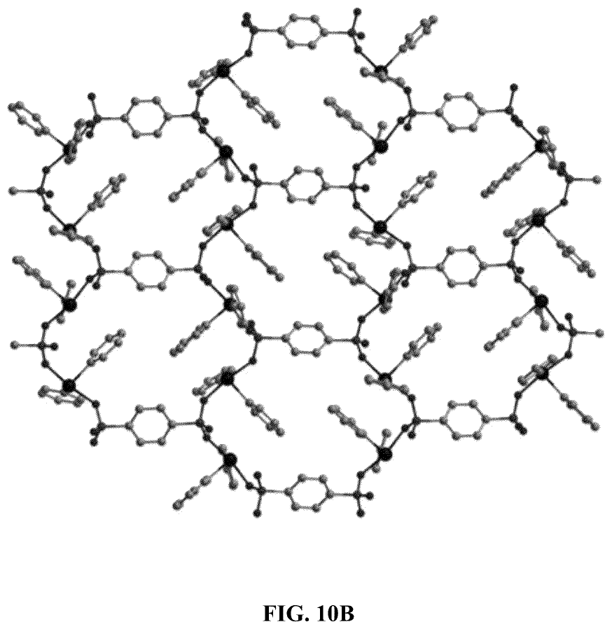

Referring to FIGS. 10A-10B, each phosphite group (PO₃) in the ligand connects two other ligands through Te atoms to form a 4-connected node, and these units further link together through —O—Te—P— bonds to generate a 2D hexagonal layer structure. In addition, the organic ligand (1,4-phenylenebis (phosphonic acid)) and ethanol solvent display strong guest-host interactions within the framework.

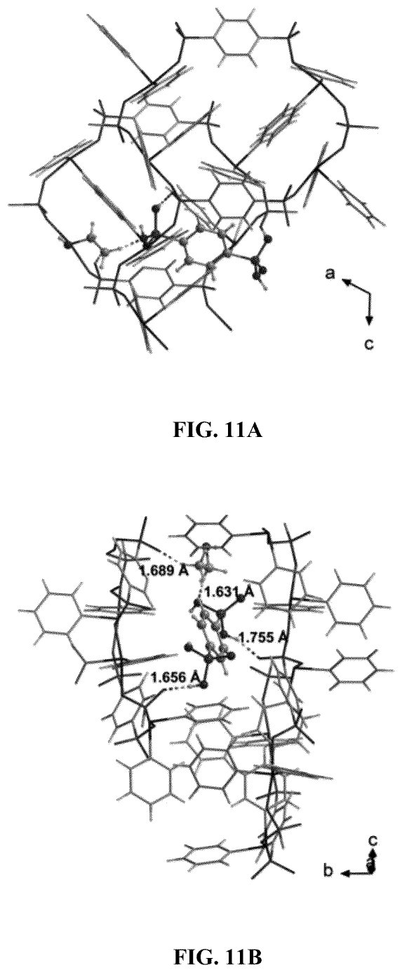

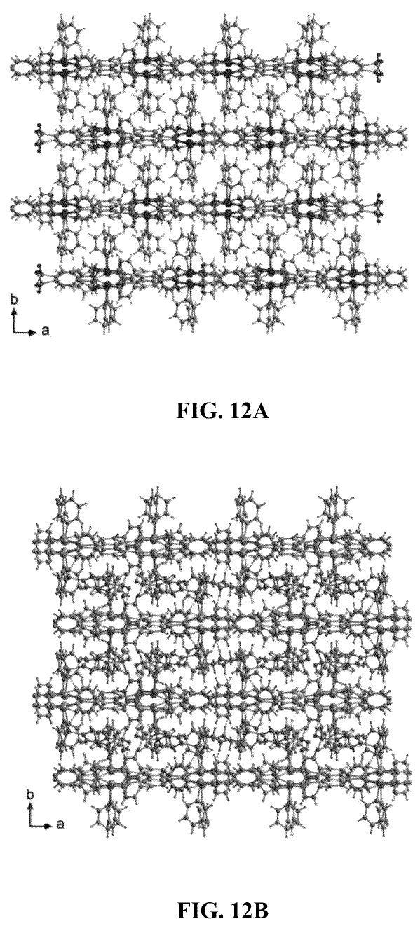

FIGS. 11A-11B provides a detailed investigation of guest-host interaction in COP-1. It reveals that there exist hydrogen bonding interactions (O—H . . . O═P distance of 1.656 Å-1.755 Å) between guest 1,4-phenylenebis (phosphonic acid) and the frameworks, as well as H—O . . . H—C interactions with the distance of 1.631 Å between building units and guest molecules (ethanol). Meanwhile, C—H . . . O═P (distance of 1.689 Å) interactions are found in solvent molecules (ethanol) and the framework. As a result, the guests (1,4-phenylenebis (phosphonic acid) and ethanol) are closely arranged between layers of the framework through guest-host interactions, generating a pseudo-3D structure, as shown in FIGS. 12A-12B.

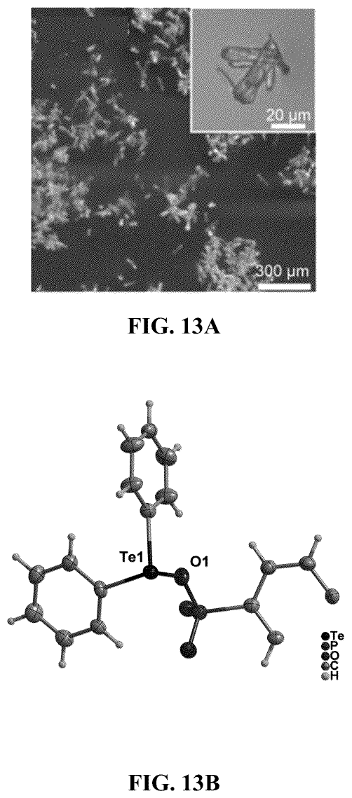

If 1,4-phenylenebis (phosphonic acid) is replaced with naphthalene-2,6-diylbis (phosphonic acid), rectangular colorless crystals (named COP-2) with the size of 80 μm to 100 μm Are obtained under a similar reaction condition (FIG. 13A). COP-2 crystallizes in the space group C2/c with an asymmetric unit containing one Te(phenyl)₂ unit and a half naphthalene-2,6-(PO₃)₂ moiety (FIG. 13B, Tables 4-6).

TABLE 4
Crystal data and structure refinement of COP-1 and COP-2

| | COP-1 | COP-2 |
|---|---|---|
| Empirical | C₇₀H₆₈O₂₀P₆Te₄ | C₁₇H₁₃O₃PTe |
| formula | | |
| Formula weight | 1925.46 | 423.84 |
| Crystal system | monoclinic | monoclinic |
| Space group | P2₁/c | C2/c |
| a (Å) | 22.7369(3) | 24.0140(6) |
| b (Å) | 17.5979(2) | 11.2420(3) |
| c (Å) | 20.0455(3) | 10.7271(3) |
| α (°) | 90 | 90 |
| β (°) | 115.834(2) | 91.553(2) |
| γ (°) | 90 | 90 |
| V (Å³) | 7219.1(2) | 2894.88(13) |
| Z | 4 | 8 |
| D_{calc}(g · cm⁻³) | 1.772 | 1.945 |
| Abs.coeff.(mm⁻¹) | 14.500 | 17.363 |
| F(000) | 3784.0 | 1648.0 |
| Reflns collected | 38911 | 4770 |
| GOFon F² | 1.039 | 1.082 |
| R₁^{a} | 0.0340 | 0.0713 |
| wR₂(all data)^{b} | 0.0870 | 0.1947 |
| CCDC number | 2339861 | 2339863 |

^{a}R₁ = Σ||Fₒ| − [F_{c}||/Σ|Fₒ|.
^{b}wR₂ = |Σw (|Fₒ|² − |F_{c}|²)|/Σ|w(Fₒ²)²|^{1/2}

TABLE 5
Selected bond distance (Å) for COP-2

| Atom1 | Atom2 | Length/Å |
|---|---|---|
| Te1 | O1 | 2.154(6) |
| Te1 | O2¹ | 2.120(6) |
| Te1 | C1 | 2.154(10) |
| Te1 | C7 | 2.104(8) |
| P1 | O1 | 1.543(6) |
| P1 | O2 | 1.566(5) |
| P1 | O3 | 1.477(7) |
| P1 | C3 | 1.802(9) |

¹+X, 1 − Y, ½ + Z

TABLE 6
Selected bond angles (°) for COP-2

| Atom1 | Atom2 | Atom3 | Angles (°) |
|---|---|---|---|
| O1 | Te1 | C1 | 84.4(3) |
| O2¹ | Te1 | O1 | 168.0(2) |
| O2¹ | Te1 | C1 | 88.6(3) |
| C7 | Te1 | O1 | 86.3(3) |
| C7 | Te1 | O2¹ | 85.0(3) |
| C7 | Te1 | C1 | 97.2(3) |
| P1 | O1 | Te1 | 131.0(4) |
| P1 | O2 | Te1² | 120.8(4) |
| C11 | C1 | Te1 | 120.7(7) |
| C16 | C1 | Te1 | 120.2(7) |
| C2 | C7 | Te1 | 119.5(7) |
| C12 | C7 | Te1 | 120.1(6) |

¹+X, 1 − Y, ½ + Z;
²+X, 1 − Y, −½ + Z

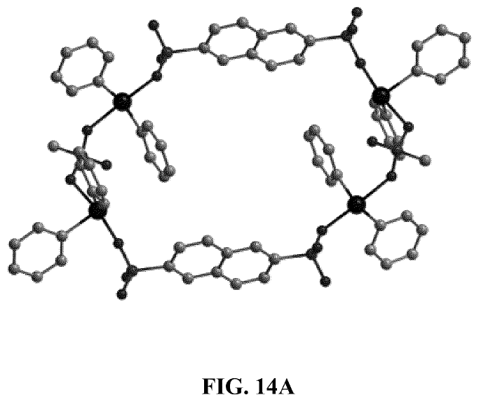

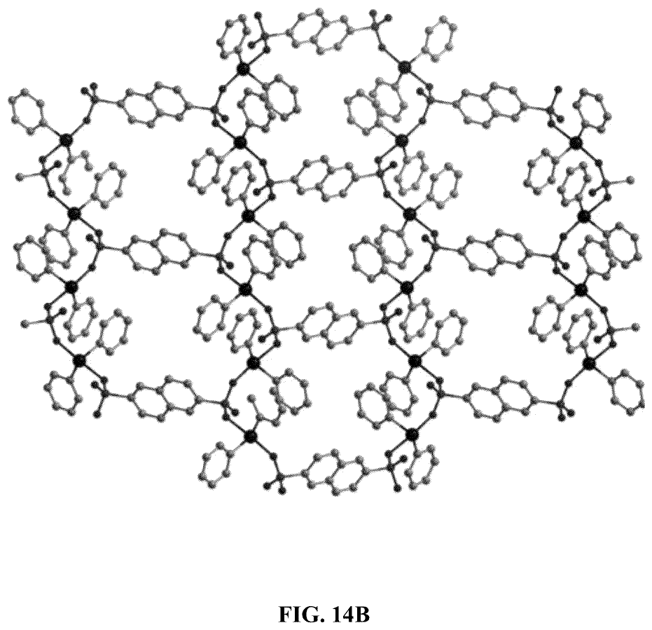

In COP-2, the connection type between Te and phosphite ligand is almost the same as that in COP-1, which makes COP-2 exhibit a 2D structure isomorphic to COP-1 (FIGS. 14A-14B).

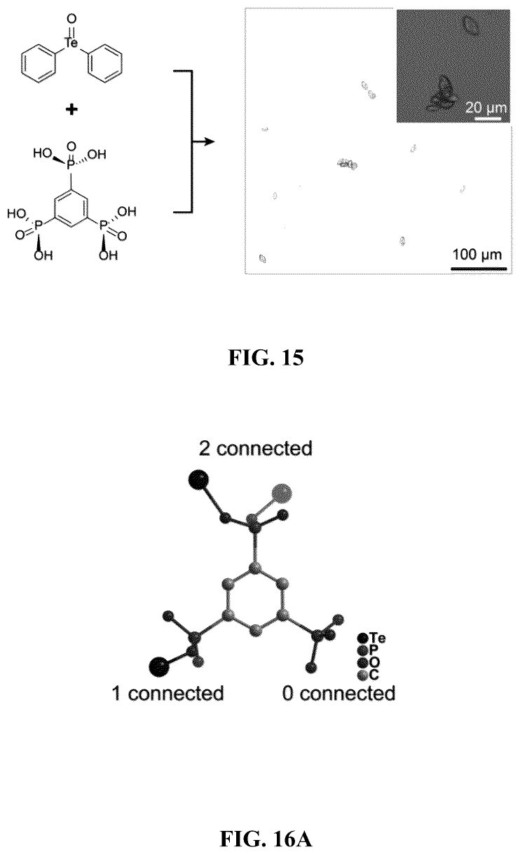

The configuration of the phosphite ligands (e.g., benzene-1,3,5-triyltris (phosphonic acid)) is further extended. Using a similar method, COP-3 crystalizes in elliptic colorless crystals with an average size of 30 μm to 50 μm (FIG. 15). The space group of COP-3 is determined to be C2/c with an asymmetric unit consisting of one benzene-1-[PO₃]-3-[HPO₃]-5-[H₂PO₃] moiety and 1.5 crystallographic independent Te(phenyl)₂ units (FIG. 15 and Tables 7-9). These positions of H atoms of [HPO₃] and [H₂PO₃] units are also determined through the different bond lengths of HO—P (1.530, 1.535 and 1.543 Å) and O═P (1.497 and 1.503 Å) (Table 8).

TABLE 7
Crystal data and structure refinement of COP-3 and COP-4

| | COP-3 | COP-4 |
|---|---|---|
| Empirical | C₄₈H₄₂O₁₈P₆Te₃ | C₄₈H₃₇O₉P₃Te₂ |
| formula | | |
| Formula weight | 1475.43 | 1105.88 |
| Crystal system | monoclinic | orthorhombic |
| Space group | C2/c | Fddd |
| a (Å) | 17.7714(4) | 20.6082(4) |
| b (Å) | 20.2914(3) | 33.1135(5) |
| c (Å) | 15.9382(3) | 64.3336(11) |
| α (°) | 90 | 90 |
| β (°) | 113.910(3) | 90 |
| γ (°) | 90 | 90 |
| V (Å³) | 5254.2(2) | 43901.9(13) |
| Z | 4 | 32 |
| Dcalc(g · cm⁻³) | 1.865 | 1.339 |
| Abs.coeff.(mm⁻¹) | 15.423 | 9.601 |
| F(000) | 2880.0 | 17472.0 |
| Reflns collected | 16452 | 32671 |
| GOFon F² | 1.053 | 1.034 |
| R₁^{a} | 0.0463 | 0.0881 |
| wR₂(all data)^{b} | 0.1175 | 0.2096 |
| CCDC number | 2339865 | 2339866 |

^{a}R₁ = Σ||Fₒ| − [F_{c}||/Σ|Fₒ|.
^{b}wR₂ = |Σw (|Fₒ|² − |F_{c}|²)|/Σ|w(Fₒ²)²|^{1/2}

TABLE 8
Selected bond distance (Å) for COP-3

| Atom1 | Atom2 | Length/Å |
|---|---|---|
| Te1 | O2¹ | 2.112(3) |
| Te1 | O2 | 2.112(3) |
| Te1 | C7 | 2.095(6) |
| Te1 | C7¹ | 2.095(6) |
| Te2 | O1² | 2.121(4) |
| Te2 | O5 | 2.078(4) |
| Te2 | C8 | 2.129(6) |
| Te2 | C9 | 2.108(7) |
| P1 | O4 | 1.543(4) |
| P1 | O7 | 1.530(4) |
| P1 | O9 | 1.503(4) |
| P2 | O5 | 1.542(4) |
| P2 | O6 | 1.535(4) |
| P2 | O8 | 1.497(4) |
| P3 | O1 | 1.544(4) |
| P3 | O2 | 1.550(4) |
| P3 | O3 | 1.490(4) |

¹1 − X, +Y, ½ − Z;
²½ − X, ½ + Y, ½ − Z

TABLE 9
Selected bond angles (°) for COP-3

| Atom1 | Atom2 | Atom3 | Angles (°) |
|---|---|---|---|
| O2¹ | Te1 | O2 | 165.1(2) |
| C7 | Te1 | O2 | 84.01(19) |
| C7 | Te1 | O2¹ | 86.60(19) |
| C7¹ | Te1 | O2¹ | 84.01(19) |
| C7¹ | Te1 | O2 | 86.60(19) |
| C7 | Te1 | C7¹ | 102.0(4) |
| O1² | Te2 | C8 | 85.4(2) |
| O5 | Te2 | O1² | 167.46(16) |
| O5 | Te2 | C8 | 84.2(2) |
| O5 | Te2 | C9 | 89.1(3) |
| C9 | Te2 | O1² | 85.5(2) |
| C9 | Te2 | C8 | 97.8(3) |
| O2¹ | Te1 | O2 | 165.1(2) |
| C12 | C7 | Te1 | 117.4(5) |
| C18 | C7 | Te1 | 121.0(5) |
| C10 | C8 | Te2 | 120.8(5) |
| C13 | C8 | Te2 | 119.9(5) |
| C14 | C9 | Te2 | 118.2(6) |
| C21 | C9 | Te2 | 119.7(6) |

¹1 − X, +Y, ½ − Z;
²½ − X, ½ + Y, ½ − Z

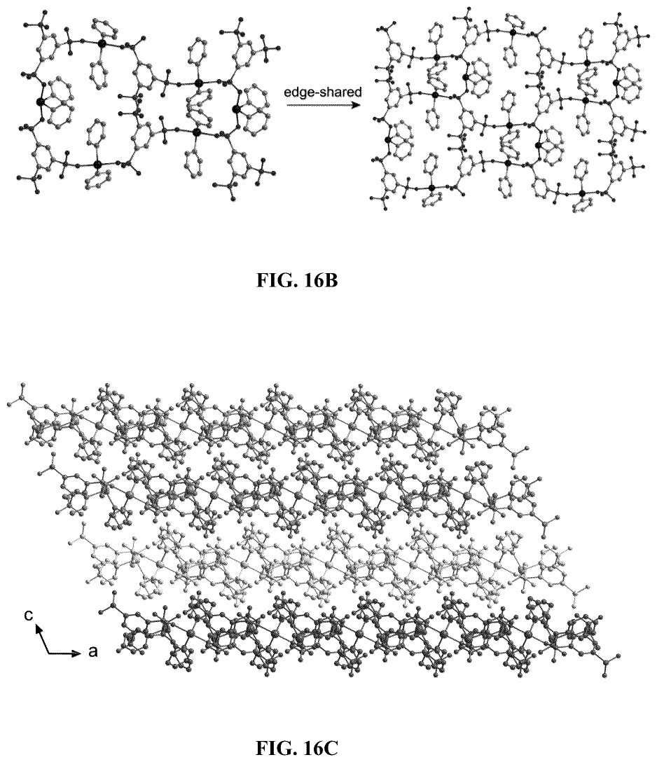

In this structure, six Te(phenyl)₂ units and six benzene-1-[PO₃]-3-[HPO₃]-5-[H₂PO₃] moieties formed bowling-shaped macrocycles (FIGS. 16A-16B). Then, these bowling-shaped macrocycles constituted a 2D COF via an edge-shared manner (FIGS. 16B-16C). The detailed analyses show that only three OH groups in the molecule of benzene-1,3,5-triyltris (phosphonic acid) are reacted with tellurinyldibenzene, and another three OH groups are left unreacted. The existence of unreacted OH groups may be caused by the large steric hindrance of tellurinyldibenzene on the small size of 1,3,5-tri-substituted benzene ring after some OH groups have already reacted.

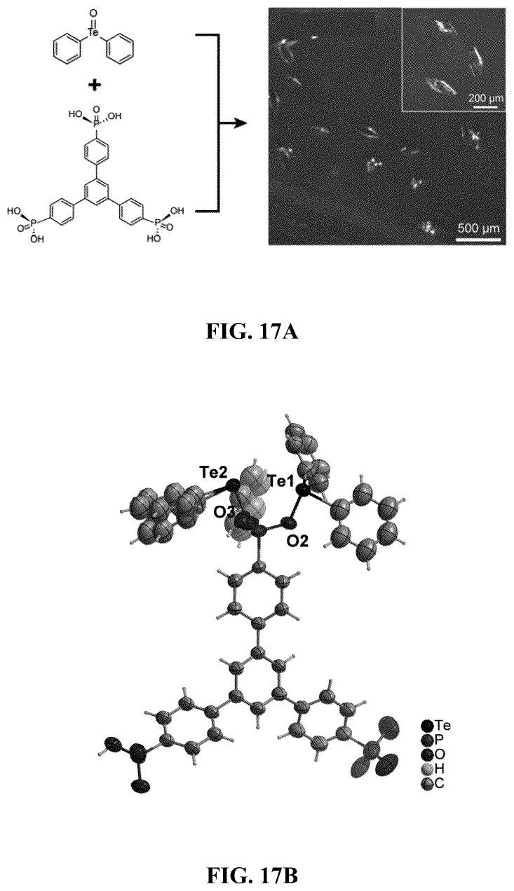

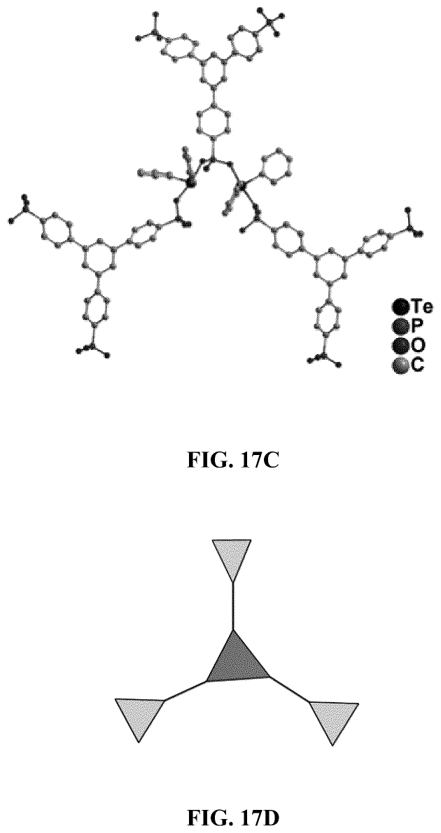

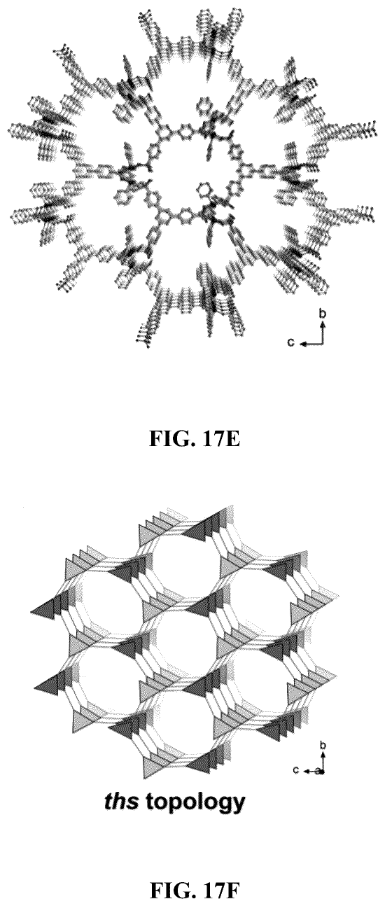

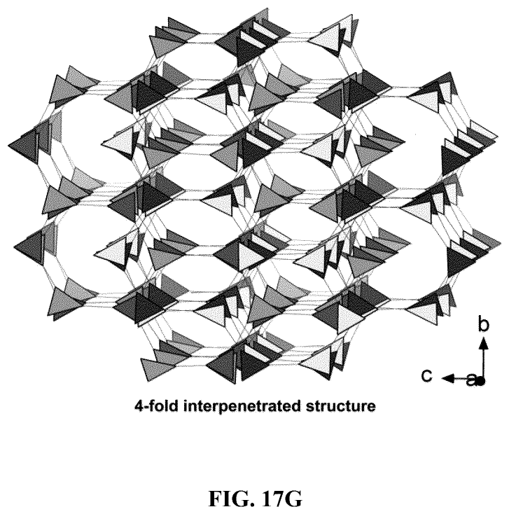

Furthermore, a larger organic ligand, 1,3,5-tris (4-phosphonophenyl) benzene, is used to produce COP-4, single crystals with sizes larger than 200 μm (FIG. 17A). The space group of COP-4 is determined as Fddd with an asymmetric unit containing two Te(phenyl)₂ units and one benzene-1-[4-phenyl-PO₃]-3,5-[4-phenyl-HPO₃]₂ moiety (FIG. 17B). Compared to benzene-1,3,5-triyltris (phosphonic acid) in COP-3, the larger size and smaller spatial site resistance of the ligand in COP-4 allow more phosphate groups to react with tellurinyldibenzene. Every two Te(phenyl)₂ units and three phosphite groups form a triangular configuration of a 3-connection node (FIGS. 17C-17D). Every ligand is connected to three such nodes, and ultimately forms a 4-interpenetrated ths topology structure (FIGS. 17E-17G).

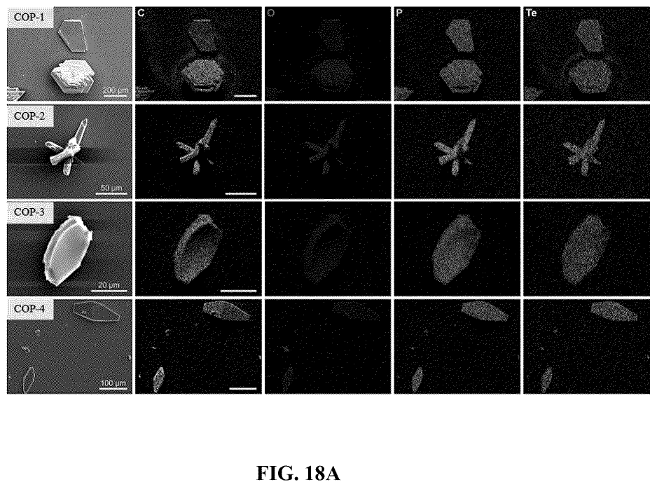

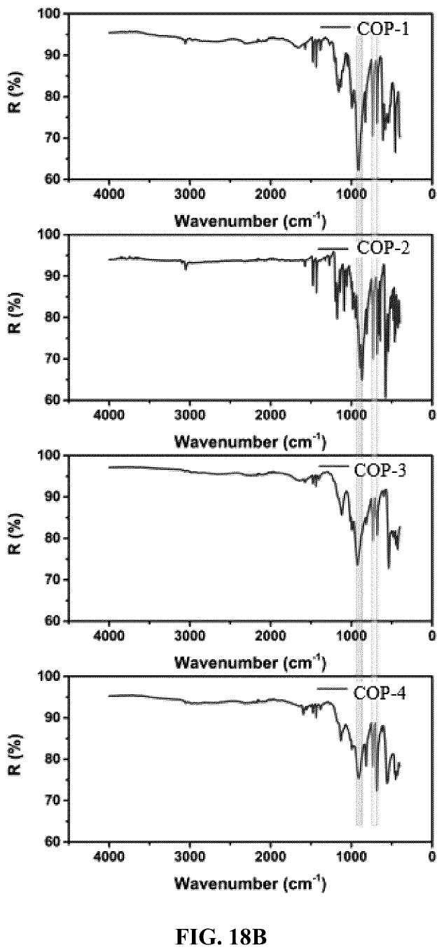

SEM and mapping and FTIR analyses are employed to further confirm the structures of COP-1 to COP-4 frameworks. PXRD characterization is carried out to confirm that all single crystals and accordingly bulk are the same phase. SEM micrographs and the corresponding mappings suggest that these crystals contain carbon, oxygen, phosphorus, and tellurium elements (FIG. 18A). Referring to FIG. 18B, FTIR spectra shows the peaks in the range of 800-570 cm⁻¹ and the peaks in the range of 950-850 cm⁻¹, respectively, come from the stretching of Te—O bonds and P—O bonds in these frameworks, further proving the formation of a new linkage (—Te—O—P(═O)—) in these frameworks.

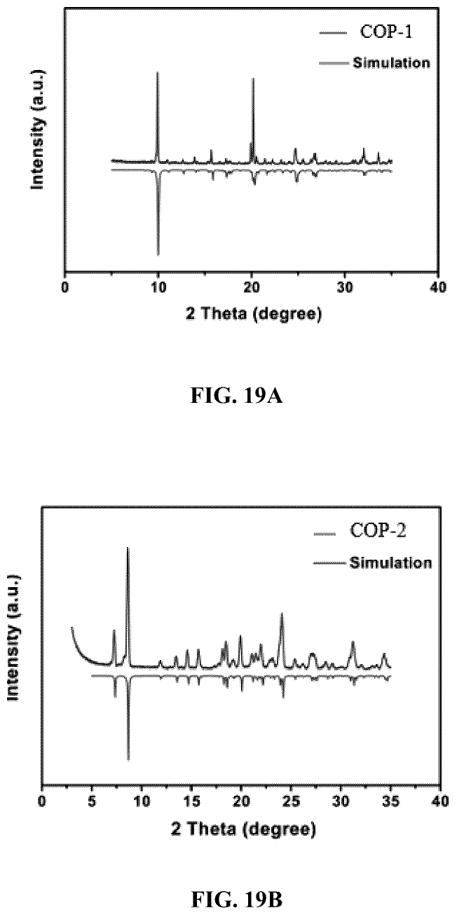

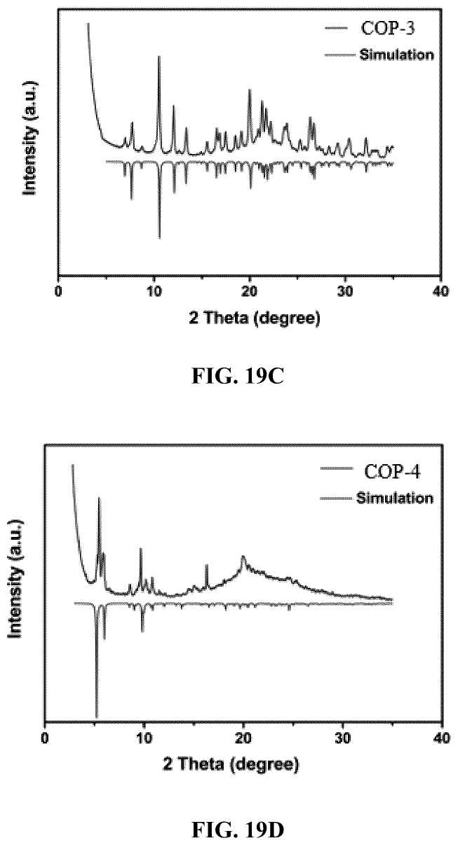

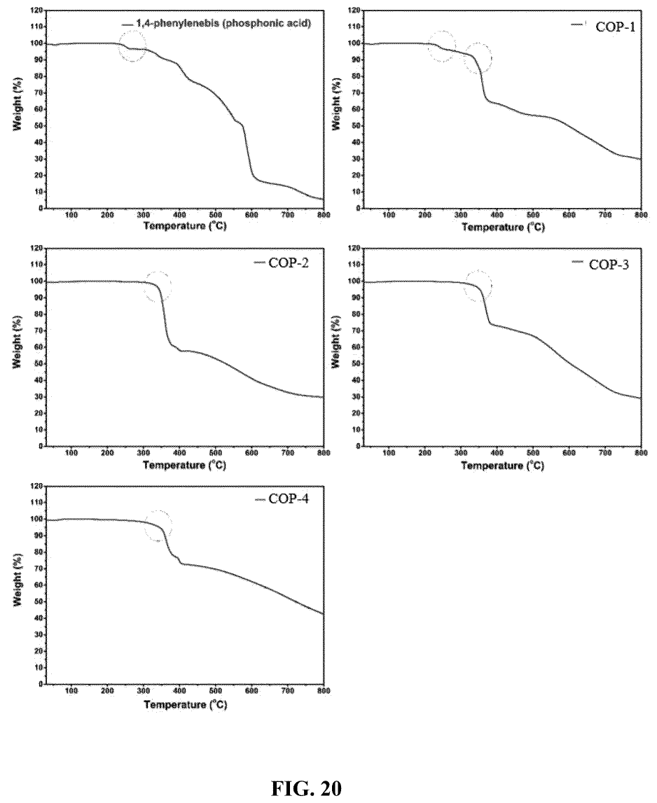

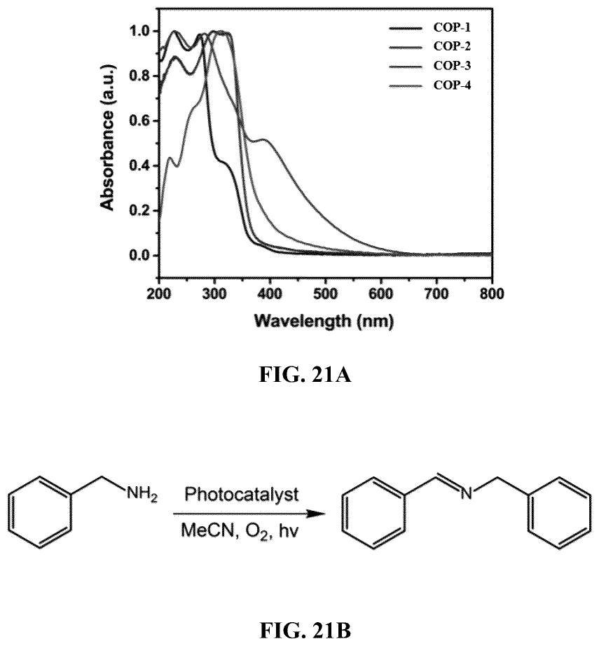

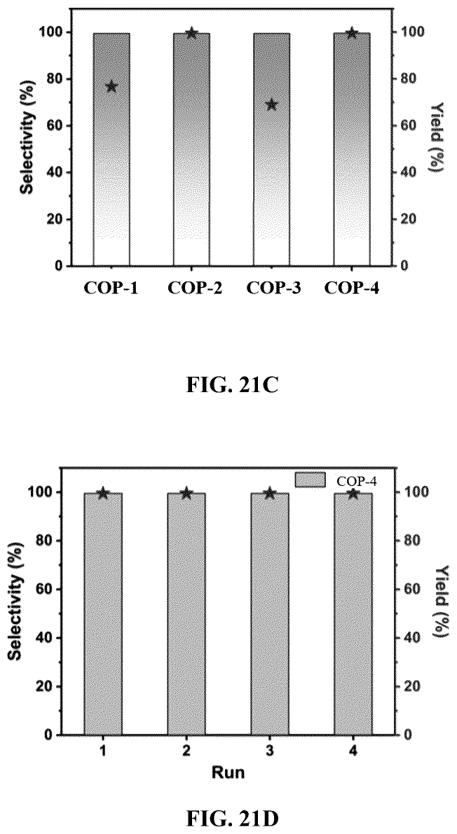

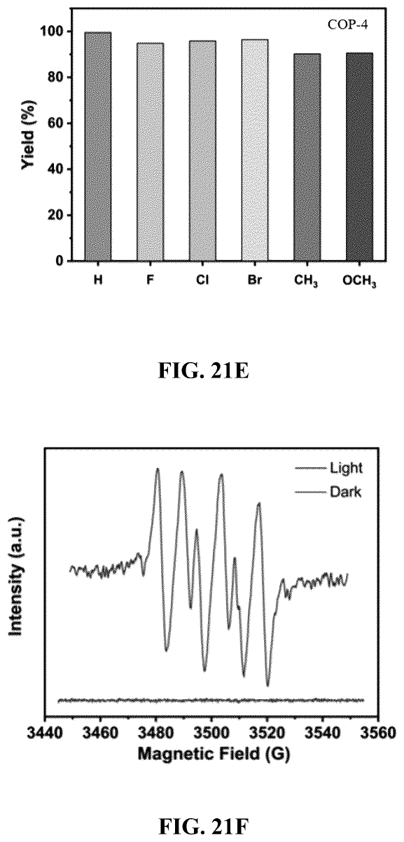

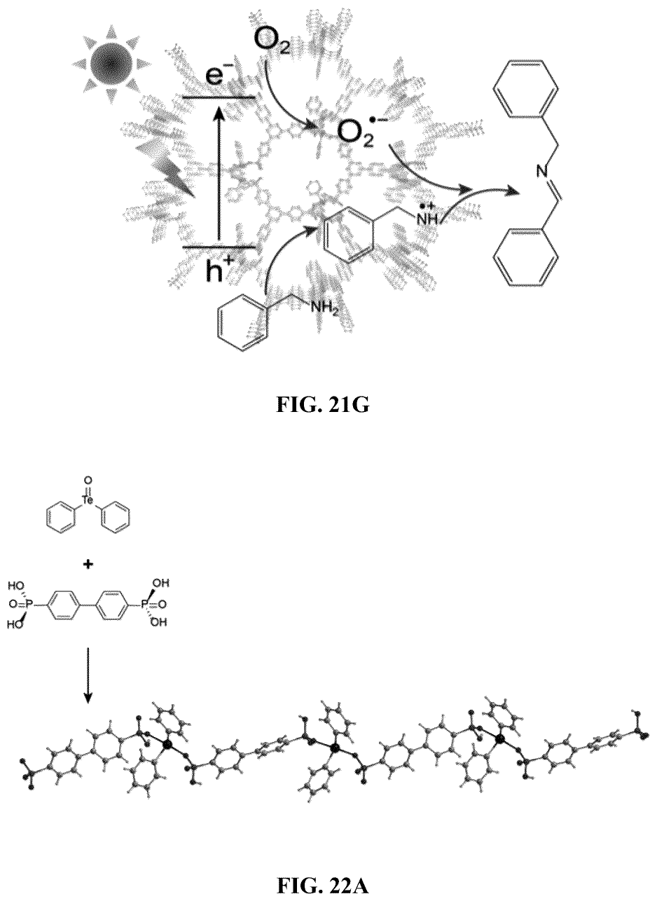

As shown in FIGS. 19A-19D, these data from bulk samples match well with their simulated powder diffraction pattern from single-crystal diffraction data of COP-1 to COP-4, respectively, proving their high phase purity. After being immersed in and washed with common solvents such as dichloromethane, hexane, methanol, 1,4-dioxane, dimethylformamide, water, and ethanol in turn for 30 min, all crystals remained insoluble and maintained their original crystallinity. Besides, thermal gravimetric analyses (TGA) indicate their high thermal stability (larger than 300° C. by considering 5% weight loss temperature (T_{d}); T_{d}=340° C., 344° C., 353° C., and 347° C. for COP-1 to COP-4, respectively, FIG. 20). The slight weight loss of COP-1 around 240° C. can be attributed to the decomposition of the guest molecules (1,4-phenylenebis (phosphonic acid) and ethanol) in the framework. The light absorption of four compounds is studied using ultraviolet-visible (UV-Vis) spectroscopy (FIG. 21A). The absorption wavelengths of COP-1 and COP-2 are mainly in the range of 230-380 nm and 240-400 nm, respectively. The slight red-shift absorption of COP-2 is caused by the larger conjugation of naphthalenyl parts in the COP-2 than phenyl parts in the COP-1. The absorptions of COP-3 and COP-4 are mainly located in the range of 230-500 nm and 280-420 nm, respectively. Accordingly, the band gaps for COP-1 to COP-4 are calculated to be 3.39 eV, 3.26 eV, 2.38 eV, and 2.95 eV, respectively.

Inspired by the UV-Vis results and the metalloid properties of tellurium, it can be speculated that COP-1 to COP-4 may absorb UV-visible light energy, serving as potential energy reservoirs. This suggests that these polymers might exhibit photocatalytic performance.

As shown in FIG. 21B, the photocatalytic activities in superoxide anion-mediated coupling of arylmethyl amines are examined to explore the photocatalytic performance of these frameworks. Firstly, 10 mg fresh samples of COP-1 to COP-4 crystals are used as photocatalysts in the system of 3 mL acetonitrile (CH₃CN) as the solvent and 0.1 mmol benzylamine as substrate. Then, the reaction is performed under an oxygen atmosphere at room temperature, irradiating with a xenon lamp of the light source (320-780 nm). The yield and selectivity of the products for the reaction are determined by gas chromatography (GC) spectrometry. After a 10-hour reaction, all COPs show satisfying performance as photocatalysts for the oxidation of primary amines to imines. Among them, COP-2 and COP-4 exhibit excellent performance with nearly 100% selectivity and 100% yield (FIG. 21C). Notably, COP-4 maintains sustained photocatalytic activity after five runs of the catalytic reaction (FIG. 21D).

In addition, several derivatives of benzylamine as substrates are further studied under the same condition with COP-4 as the photocatalyst (FIG. 21E). When the substrates decorate with electron-withdrawing groups such as p-F, p-Cl, p-Br, the targeted yields can keep between 95% to 100%. When the substrate contains electron-donating groups such as p-CH₃ and p-OCH₃, the targeted yield has a slight decrease but still can reach 90%. To elucidate the reaction mechanism, in-situ electron paramagnetic resonance (EPR) spectroscopy of COP-4 is further exploited. As shown in FIG. 21F, there is no obvious signal in the oxygen atmosphere under dark conditions. However, after 30 min of illumination, the signals of superoxide radical (O₂·⁻) appear clearly with the presence of 5,5-dimethyl-1-pyrroline N-oxide (DMPO), indicating that COP-4 can activate oxygen molecules to superoxide radicals in a short time under light irradiation for the subsequent oxidation of the substrates to products (FIG. 21G).

### Synthesis of RTP Single Crystals COP-5

This example further provides RTP single crystals of a COP containing Te—O—P bonds by introducing heavy atoms (tellurium) and [P═O] groups into the backbone of COP-5 to prompt the SOC process. Unlike traditional COPs, a heavy element (tellurium) from group VI is employed to create the polymer backbone and develop COP-5. In this structure, metal-free organic ligands are covalently linked through Te—O—P bonds, leading to the formation of polymer chains.

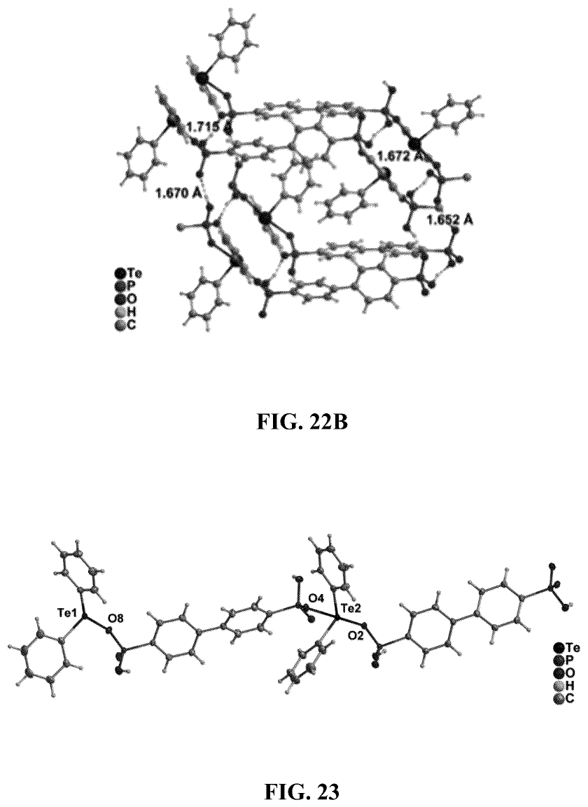

As mentioned earlier, tellurinyldibenzene is first synthesized first: ¹H NMR (400 MHz, d₄-MeOH): δ (ppm) 7.55-7.62 (m, 6H), 7.88-7.93 (m, 4H); ¹³C NMR (400 MHz, d₄-MeOH): δ (ppm) 134.7, 132.3, 130.9, 129.3. 15.0 mg, 0.05 mmol of tellurinyldibenzene, 6.5 mg, 0.021 mmol of [1,1′-biphenyl]-4,4′-diylbis (phosphonic acid) and 160 μL acetic acid are dissolved in a mixture of 0.7 ml of absolute ethanol and 0.2 mL of 1,4-dioxane are added to a glass ampoule. After ultrasonication, the glass ampoule is frozen in an aqueous liquid nitrogen bath, evacuated three times, and then sealed under a vacuum atmosphere. After heating at 100° C. for 2 days, large-size colorless crystals are formed. Then, the glass ampoule is cooled to room temperature, and these crystals are collected by filtration. These crystals are further washed with methanol, 1,4-dioxane, deionized water, and ethanol in turn. Then, these crystals are dried under a vacuum to afford colorless COP-5 (14.9 mg, 72% yield) (FIG. 22A).

### Characterization

Photoluminescence, phosphorescence spectra, lifetimes, and quantum yield of single crystals of COP-5 are determined on an FLS980 spectrometer at room temperature in the air. The photos of RTP phenomena for single crystals of COP-5 are taken by Nikon Z9.

SCXRD analysis indicates that COP-5 belongs to the space group of P-1 (a=9.41547(15) Å, b=10.53235(17) Å, c=23.2502(2) Å, Table 10-12) with the asymmetric unit containing two Te(phenyl)₂ units and two [1,1′-biphenyl]-4,4′-[(PO₂)OH]₂ (FIG. 23).

Because the heavy-atom (Te) effect in COP-5 can generate a more significant amount of SOC to facilitate the ISC process, and the strong hydrogen bonding interaction can enhance the stability and rigidity of its structure to suppress the energy loss of the non-radiative transition, single crystals of COP-5 show excellent RTP performance with a lifetime of 179 ms@540 nm and 158 ms@565 nm.

TABLE 10
Crystal data and structure refinement of COP-5

| | COP-5 |
|---|---|
| Empirical | C₄₈H₄₀O₁₂P₄Te₂ |
| formula | |
| Formula weight | 1187.88 |
| Crystal system | triclinic |
| Space group | P-1 |
| a (Å) | 9.41547(15) |
| b (Å) | 10.53235(17) |
| c (Å) | 23.2502(2) |
| α (°) | 93.7232(11) |
| β (°) | 99.2727(11) |
| γ (°) | 91.1692(13) |
| V (Å³) | 2269.61(6) |
| Z | 2 |
| D_{calc}(g · cm⁻³) | 1.738 |
| Abs.coeff.(mm⁻¹) | 12.029 |
| F(000) | 1176.0 |
| Reflns collected | 24255 |
| GOFon F² | 1.056 |
| R₁^{a} | 0.0244 |
| wR₂(all data)^{b} | 0.0586 |
| CCDC number | 2339864 |

TABLE 11
Selected bond distance (Å) for COP-5

| Atom1 | Atom2 | Length/Å |
|---|---|---|
| Te1 | O1¹ | 2.1181(18) |
| Te1 | O8 | 2.1126(18) |
| Te1 | C10 | 2.130(3) |
| Te1 | C16 | 2.123(3) |
| Te2 | O2 | 2.0891(18) |
| Te2 | O4 | 2.1019(18) |
| Te2 | C2 | 2.125(3) |
| Te2 | C7 | 2.134(3) |
| P1 | O2 | 1.5552(19) |
| P1 | O7 | 1.489(2) |
| P1 | O11 | 1.556(2) |
| P2 | O8 | 1.5470(19) |
| P2 | O9 | 1.503(2) |
| P2 | O12 | 1.537(2) |
| P3 | O1 | 1.5457(19) |
| P3 | O5 | 1.549(2) |
| P3 | O10 | 1.496(2) |
| P4 | O3 | 1.499(2) |
| P4 | O4 | 1.5461(19) |
| P4 | O6 | 1.5515(19) |

¹−1 + X, −2 + Y, −1 + Z

TABLE 12
Selected bond angles (°) for COP-5

| Atom1 | Atom2 | Atom3 | Angles (°) |
|---|---|---|---|
| O1¹ | Te1 | C10 | 85.59(9) |
| O1¹ | Te1 | C16 | 84.56(9) |
| O8 | Te1 | O1¹ | 167.95(7) |
| O8 | Te1 | C10 | 86.30(9) |
| O8 | Te1 | C16 | 88.34(9) |
| C16 | Te1 | C10 | 101.44(11) |
| O2 | Te2 | O4 | 166.41(8) |
| O2 | Te2 | C2 | 87.89(9) |
| O2 | Te2 | C7 | 84.91(9) |
| O4 | Te2 | C2 | 84.89(9) |
| O4 | Te2 | C7 | 85.87(9) |
| C2 | Te2 | C7 | 105.04(11) |
| C17 | C7 | Te2 | 118.2(2) |
| C35 | C7 | Te2 | 121.0(2) |
| C30 | C10 | Te1 | 119.2(2) |
| C32 | C10 | Te1 | 119.8(2) |

¹−1 + X, −2 + Y, −1 + Z

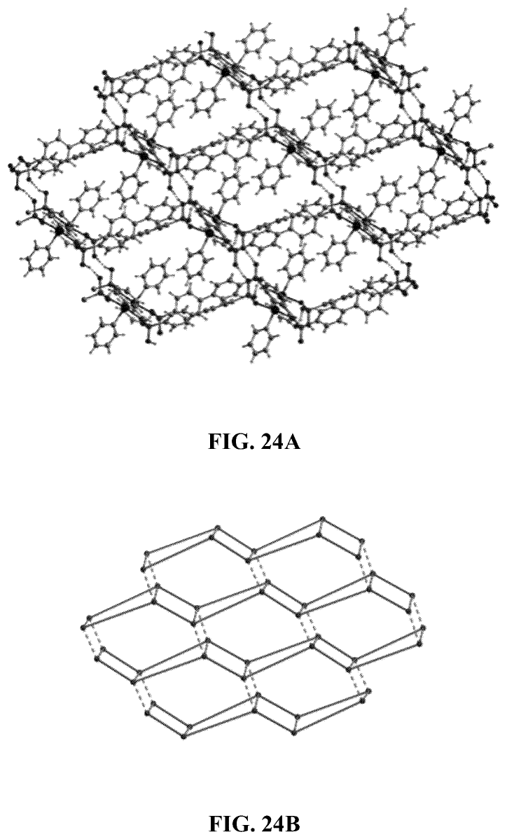

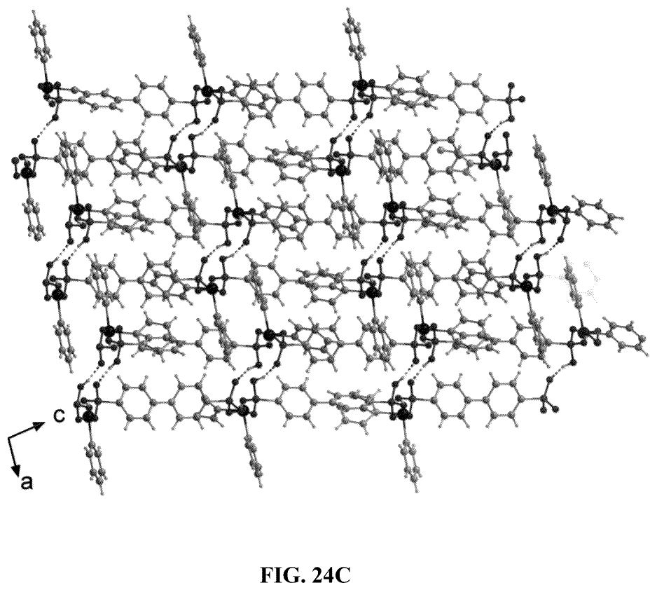

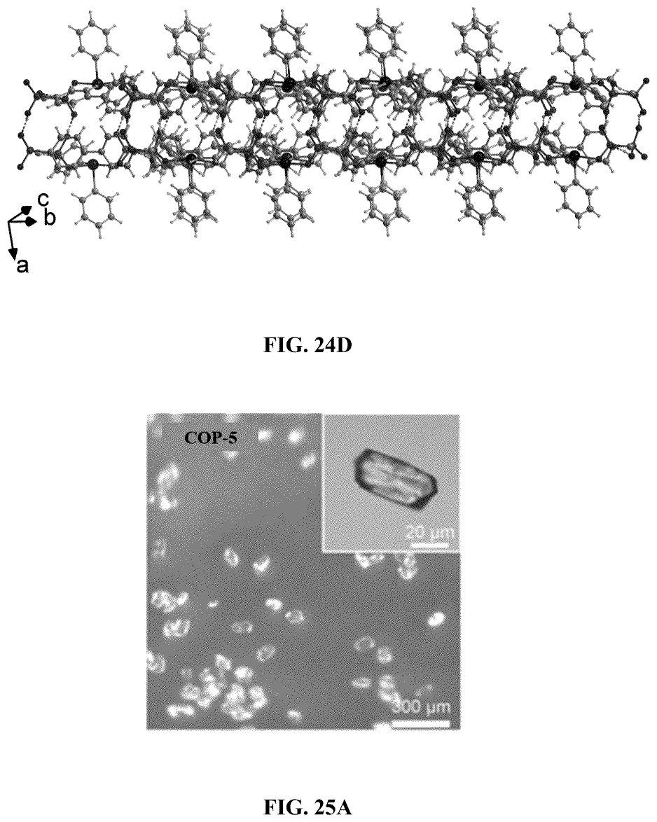

As described in Table 11, bond lengths of HO—P (1.545 to 1.555 Å) and O═P (1.489 and 1.496 Å) help to distinguish and confirm these positions of hydrogen atoms in four [HPO₃] units. One OH group from each PO₃H₂ group in the molecule of [1,1′-biphenyl]-4,4′-diylbis (phosphonic acid) reacts with tellurinyldibenzene to form a 1D COP (FIG. 22A), and the rest of OH groups kept unreacted. Strong hydrogen bonds (OH . . . O═P) with a distance of 1.652 to 1.715 Å in FIG. 22B, are formed between these unreacted OH groups from each polymer chain and the P═O units in adjoining polymer chains. These multiple hydrogen-bonding interactions prompt COP-5 to become a hydrogen-bonded pseudo-2D framework (FIGS. 24A-24D). Accordingly, these unreacted OH groups further stabilize the structure of COP-5 and restrict the vibration and movement of polymer chains.

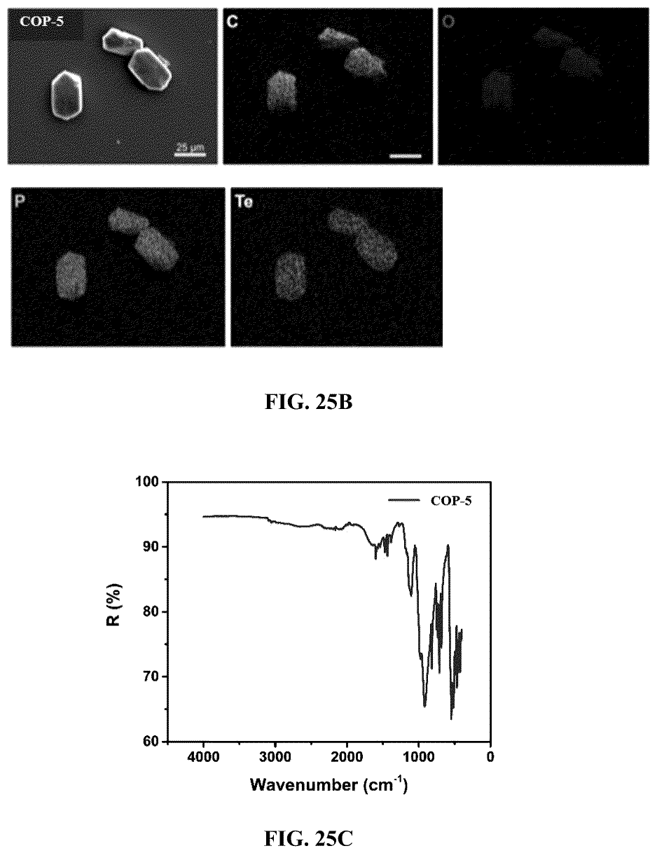

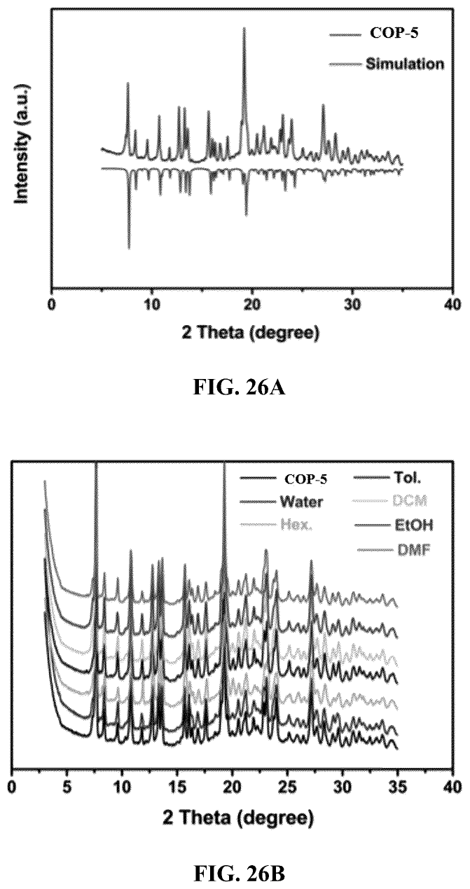

SEM and elemental mapping and FTIR analyses are used to further confirm the structure of COP-5. Referring to FIG. 25B, the SEM images and the corresponding elemental mappings suggest that single crystals of COP-5 have a quasi-cuboid shape containing the elements of carbon, oxygen, phosphorus, and tellurium. The size of single crystals is in the range of 60 μm to 90 μm (FIG. 25A). As exhibited in FIG. 25C, these peaks in the range of 790-580 cm⁻¹ result from the stretching of Te—O bonds, while these peaks in 960-840 cm⁻¹ come from P—O bonds in COP-5. As presented in FIG. 26A, the PXRD data match well with the simulated pattern from SCXRD data of COP-5, implying its high phase purity.

In addition, to confirm the solvent stability of single crystals of COP-5, these crystals are immersed for 60 hours in the different solvents including water, hexane, toluene, dichloromethane, and dimethylformamide. As shown in FIG. 26B, all solvent-treated COP-5 samples maintained their original crystallinity, indicating their high stability in different solvents.

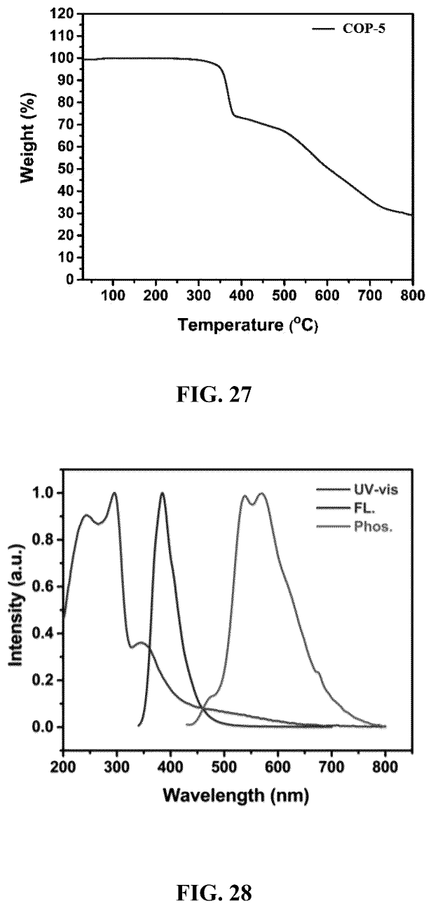

Furthermore, the thermal stability of COP-5 is studied via TGA (FIG. 27). COP-5 can be stable up to 327° C. considering a 5% weight loss, suggesting its high thermal stability. The excellent solvent/thermal stability is essential for the subsequent applications of single crystals of COP-5.

The optical properties of single crystals of COP-5 are studied using the UV-Vis absorption spectrum, the fluorescence spectrum, and the phosphorescence spectrum at RT in the air. Referring to FIG. 28, there are three pronounced UV-Vis absorption peaks, where two short-wavelength absorption peaks at 240-300 nm can be assigned to the π-π* transition from the biphenyl units and phenyl units in COP-5, and the longer wavelength at 350 nm can be ascribed to the possible charge transfer (CT) interactions between [HO₃P-Ph-Ph-PO₃H] units and Te(Ph₂) species.

Apart from the fluorescence peak at 388 nm, single crystals of COP-5 emit intense phosphorescence at room temperature under ambient conditions with two peaks at 540 nm and 565 nm, respectively, with photoluminescence quantum yield (PLQY) of 84.69%. The afterglow time of single crystals of COP-5 is 1.2 s.

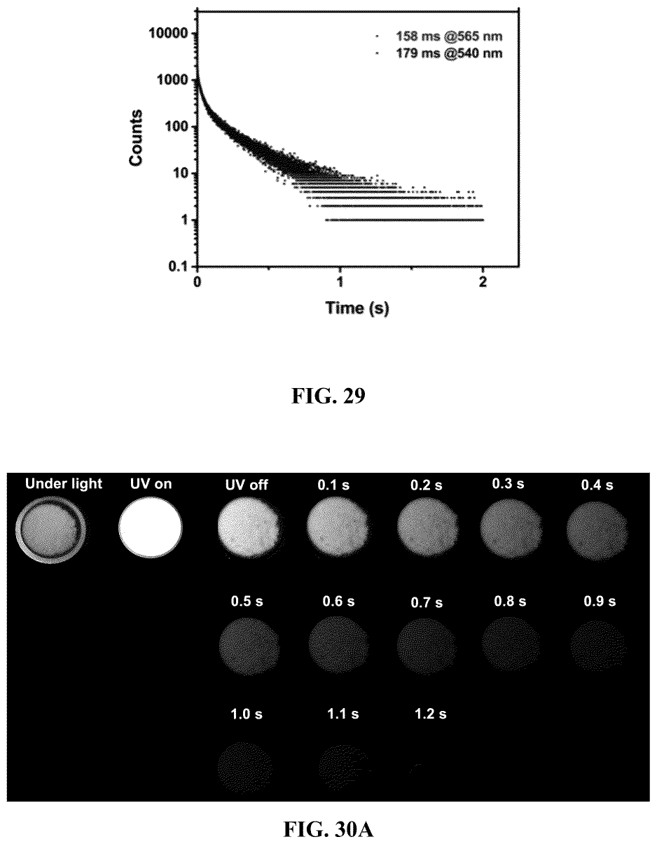

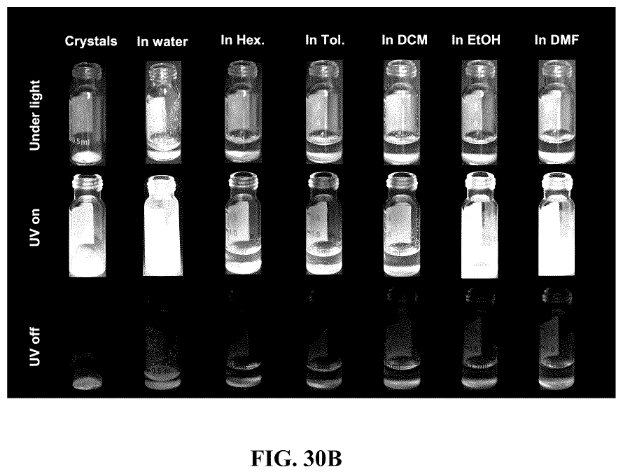

Furthermore, COP-5 has been demonstrated to show long lifetimes of 179 ms @540 nm and 158 ms @565 nm at RT in the air from the phosphorescence decay curves (FIG. 29). These results indicate that COP-5 has RTP property, which is further evidenced by photographs in FIGS. 30A-30B.

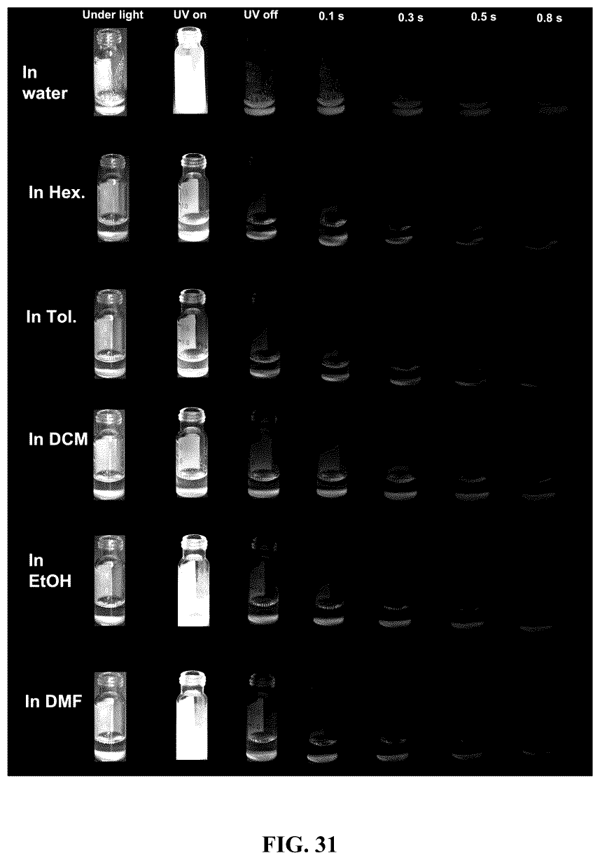

The potential reasons for COP-5 exhibiting RTP characteristics are as follows: Firstly, the P═O parts in the backbone can exhibit some degree of spin-orbit coupling, prompting intrinsic triplet generation through ISC. Secondly, the heavy atom (tellurium) in COP-5 enhances the mixture of the singlet and triplet states of excited excitons and singlet-triplet conversion. Thirdly, multiple hydrogen bonding effects not only make adjacent polymer chains close enough to form a relatively rigid hydrogen-bonded pseudo-2D structure and stabilize the whole structure, but also suppress nonradiative decay and decrease energy loss. Furthermore, due to the integrating effect of P═O parts in the backbone, the heavy atom effect and hydrogen bonds, single crystals of COP-5 display RTP in air and can maintain its RTP character in most solvents. Referring to FIGS. 30B and 31, even after the treatment with common solvents (water, hexane (hex.), toluene (Tol.), dichloromethane (DCM), and dimethylformamide (DMF)), single crystals of COP-5 display high solvent stability and maintain its crystallinity as well as its RTP character with an afterglow time of up to 0.8 s.

Besides, its structure and crystallinity remained unchanged after being immersed in different solvents for 60 h, confirmed by the PXRD curves in FIG. 26B. The high stability and good RTP behavior of COP-5 in solvents can break out of the dilemma that single crystals of RTP small molecules usually lose their crystalline state and RTP properties after solvent treatment, which can broaden the application of RTP materials.

### Example 4

### Synthesis of 3D Metal-Free Covalent Organic-Inorganic Hybrid Framework

This example successfully develops 3D metal-free covalent organic-inorganic hybrid framework crystals, reaching sizes of up to 400 μm, with non-carbon backbones. The metal-free covalent bonding in the organic-inorganic hybrid structure contributes to the exceptional stability of the polymer when exposed to various solvents or heat, effectively addressing stability challenges in the NLO field. Additionally, the non-π-conjugated backbone allows for UV absorption in the 200-300 nm range, overcoming the limitations of most NLO organic polymer-based materials, which tend to be inactive in this wavelength region.

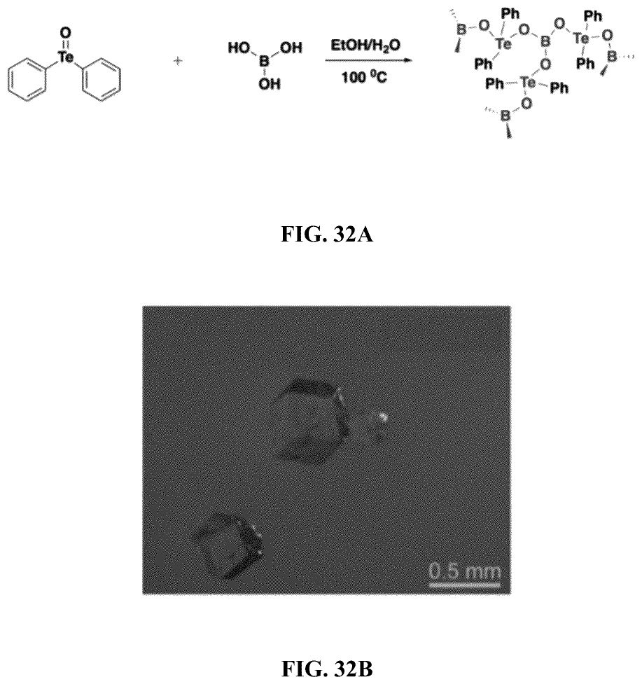

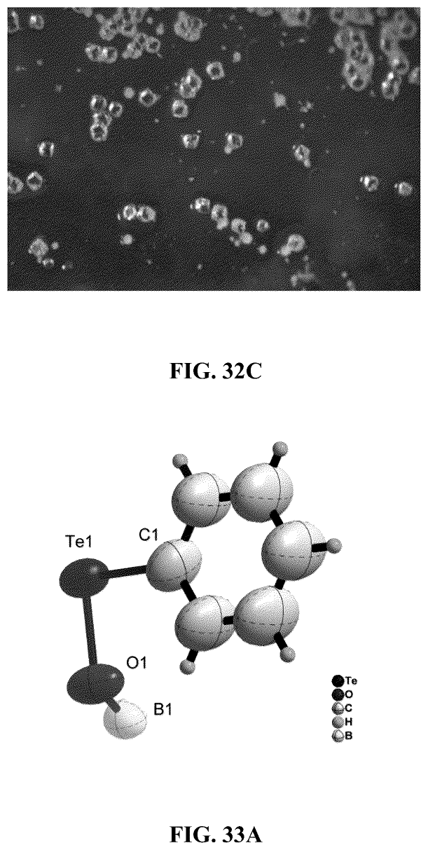

Tellurinyldibenzene is first synthesized according to Example 3: ¹H NMR (400 MHz, CDCl₃): δ (ppm) 7.38-7.43 (m, 6H), 7.73-7.75 (m, 4H). 30.0 mg, 0.20 mmol of tellurinyldibenzene and 8.2 mg, 0.13 mmol of boric acid are dissolved in a mixture of 4 ml of absolute ethanol and 4 mL of deionized water. After heating at 100° C. for 3 days, large-size colorless single crystals are formed at the bottom of the bottle (FIGS. 32A-32C). Then, these crystals are collected by filtration after cooling to room temperature. These crystals are further washed with different solvents such as dichloromethane, hexane, acetone, 1,4-dioxane, dimethylformamide, deionized water, and ethanol in turn. These crystals are dried under a vacuum to afford colorless and chiral metal-free covalent organic-inorganic hybrid framework.

### Characterization

The crystal structure for metal-free covalent organic-inorganic hybrid framework is solved and refined by full-matrix least-squares methods against F² with the SHELXL-2014 program package and Olex-2 software. The SCXRD measurement is performed using the as-synthesized crystals. The optical microscopy, SEM and mapping are carried out after gentle sonication and washed with ethanol and water.

SCXRD analysis reveals that the metal-free covalent organic-inorganic hybrid framework crystallizes in a chiral cubic space group I2₁3 (No. 199) (Z=4 per unit cell) (Table 13-15). [Te═O] units of tellurinyldibenzene reacted with OH parts in boric acid to form Te—O—B bonds.

TABLE 13
Crystal data and structure refinement of metal-
free covalent organic-inorganic hybrid framework

| | 3D metal-free |
|---|---|
| | covalent organic- |
| | inorganic hybrid |
| | framework |
| Empirical | C₃₆H₃₀B₂O₆Te₃ |
| formula | |
| Formula weight | 963.02 |
| Crystal system | Cubic |
| Space group | I2₁3 |
| a (Å) | 15.34580(10) |
| b (Å) | 15.34580(10) |
| c (Å) | 15.34580(10) |
| α (°) | 90 |
| β (°) | 90 |
| γ (°) | 90 |
| V (Å³) | 3613.84(7) |
| Z | 4 |
| D_{calc}(g · cm⁻³) | 1.770 |
| Abs.coeff.(mm⁻¹) | 19.333 |
| F(000) | 1840.0 |
| Reflns collected | 2171 |
| GOFon F² | 1.078 |
| R₁^{a} | 0.0368 |
| wR₂(all data)^{b} | 0.1038 |
| CCDC number | 2361022 |

^{a}R₁ = Σ||Fₒ| − [F_{c}||/Σ|Fₒ|.
^{b}wR₂ = |Σw (|Fₒ|² − |F_{c}|²)|/Σ|w(Fₒ²)²|^{1/2}

TABLE 14
Selected bond length (Å) for metal-free
covalent organic-inorganic hybrid framework

| Atom1 | Atom2 | Length/Å |
|---|---|---|
| Te1 | O1¹ | 2.078(6) |
| Te1 | O1 | 2.078(6) |
| Te1 | C1 | 2.104(7) |
| Te1 | C1¹ | 2.105(7) |
| O1 | B1 | 1.356(6) |
| B1 | O1² | 1.356(6) |
| B1 | O1³ | 1.356(6) |

¹1 − X, 3/2 − Y, +Z;
²+Y, +Z, +X;
³+Z, +X, +Y

TABLE 15
Selected bond angles (°) for metal-free
covalent organic-inorganic hybrid framework

| Atom1 | Atom2 | Atom3 | Angel (°) |
|---|---|---|---|
| O1¹ | Te1 | O1 | 170.3(4) |
| O1¹ | Te1 | C1¹ | 88.1(4) |
| O1 | Te1 | C1¹ | 85.7(3) |
| C1 | Te1 | C1¹ | 100.5(7) |
| B1 | O1 | Te1 | 116.5(4) |
| C2 | C1 | Te1 | 119.0(5) |
| O1 | B1 | O1² | 119.95(7) |

¹+X, 3/2 − Y, −½ + Z;
²1 + X, 3/2 − Y, ½ + Z

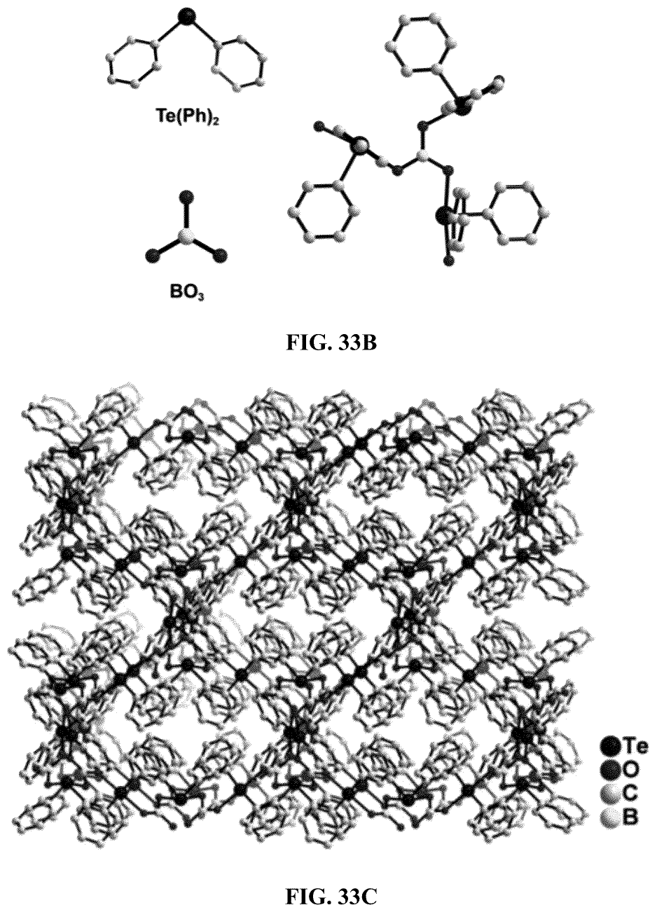

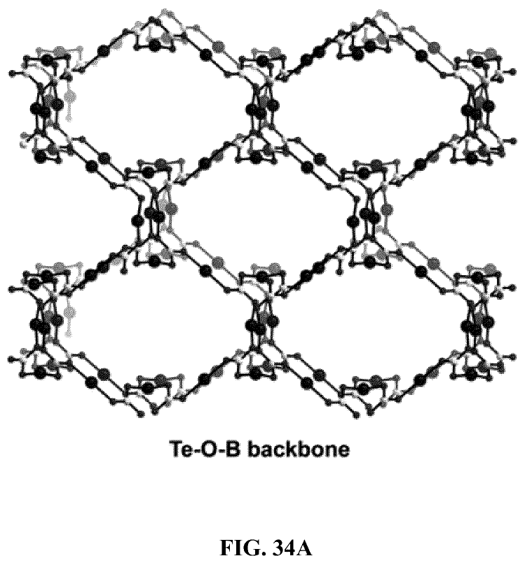

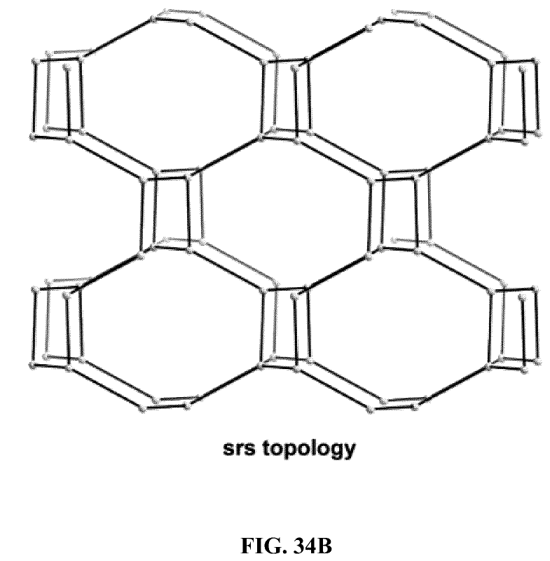

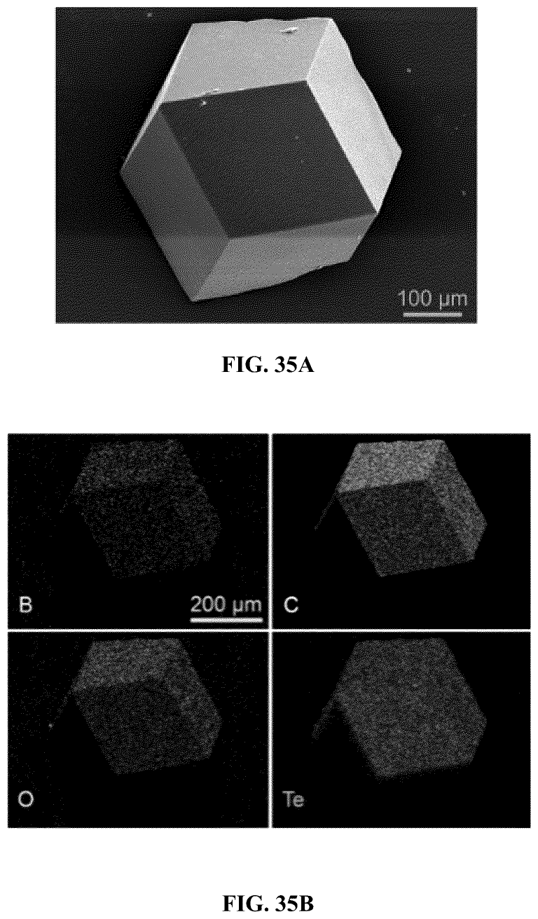

Referring to FIG. 33A, the asymmetric unit of the metal-free covalent organic-inorganic hybrid framework contains a half Te(Ph)₂ unit and a third of a borate. The 2-connection building blocks (Te(Ph)₂) are covalently linked with 3-connected BO₃ nodes to afford a Te—O—B—O backbone-based 3D framework (FIGS. 33A-33C). Topology analysis indicates that the network can be simplified to the srs topology with a [10³] Schläfli symbol (FIGS. 34A-34B).

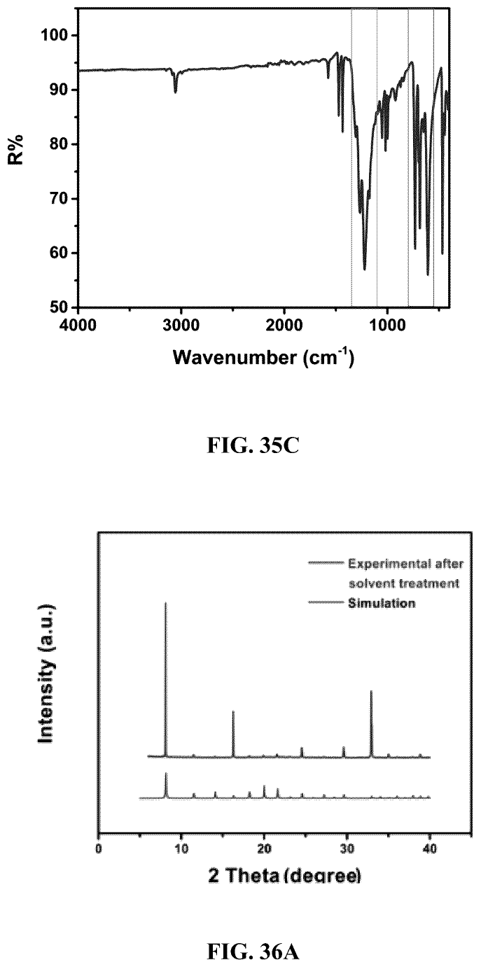

The chiral property of the metal-free covalent organic-inorganic hybrid framework crystals suggests its promising application in optics. FIG. 35A shows that all crystals possess a similar morphology with the shape of the rhombic dodecahedron and a size of up to 400 μm. The mapping characterization further confirms that the metal-free covalent organic-inorganic hybrid framework contains boron, carbon, oxygen, and tellurium elements (FIG. 35B).

Meanwhile, FTIR results show that the peaks in the range of 1278-1172 cm⁻¹ come from the stretching of B—O bonds while the peaks in the range of 742-570 cm⁻¹ belong to Te—O bonds, which further prove the formation of the backbone (—Te—O—B—O—) (FIG. 35C).

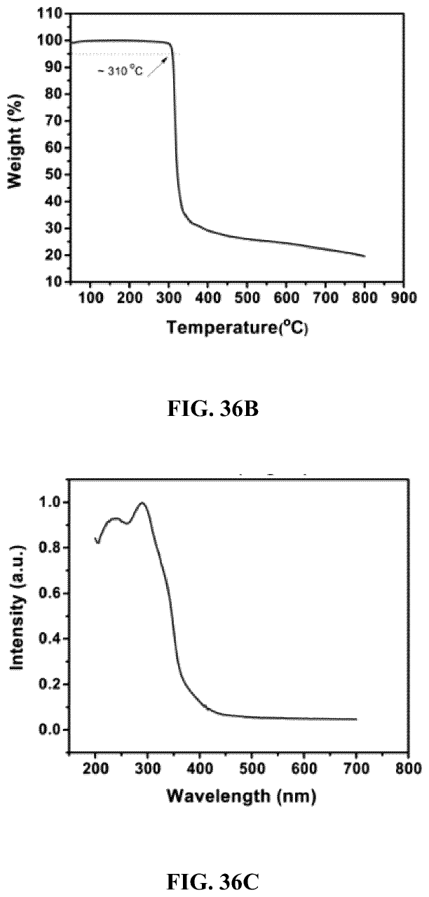

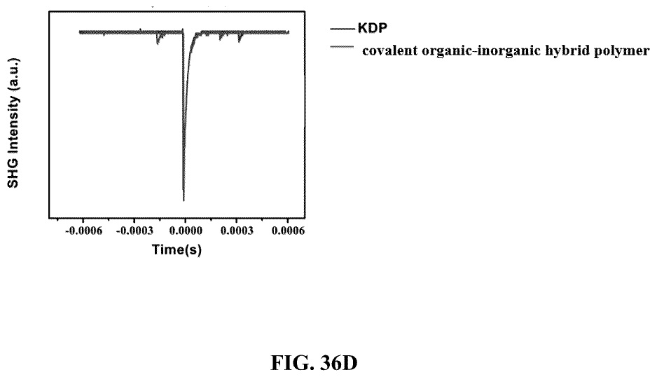

As shown in FIG. 36A, the PXRD patterns of the metal-free covalent organic-inorganic hybrid framework match well with the simulated result from its single-crystal diffraction data, indicating its high purity. The crystals of the metal-free covalent organic-inorganic hybrid framework remain stable after being immersed in common solvents such as acetone, dichloromethane, hexane, ethanol, 1,4-dioxane, dimethylformamide, and water because of its unique organic-inorganic hybrid covalent framework structure. Such stability is very important because most NLO inorganic salts (such as commercial NLO material (KDP) or organic small molecules can't maintain their crystallinity and even dissolve in polar solvents or water.

On the other hand, the metal-free covalent organic-inorganic hybrid framework also shows good thermal stability with a decomposing temperature of 310° C. considering a 5% weight loss (FIG. 36B). This thermal stability is very important since most NLO organic small molecules or hybrid molecules suffer from poor thermal stability (e.g. (C₅H₆ON)(H₂PO₄) decomposing at 166° C.). This can be attributed to the covalently connected network since covalent bonds are more stable than coordination bonds and hydrogen bonds. Although some organic NLO 1D polymers don't dissolve in common solvents and water, they normally appear as amorphous phases rather than crystalline states and usually display low SHG response.

Furthermore, most organic NLO 1D polymers are usually inactive in short-wavelength UV regions due to their large π-conjugation. Instead, organic units (Te(Ph)₂) in the metal-free covalent organic-inorganic hybrid framework are covalently linked via single bonds, resulting in a non-π-conjugated backbone. Such construction allows the absorption of the metal-free covalent organic-inorganic hybrid framework only located in the UV region (200-300 nm), displaying attractive prospects as an UV NLO material (FIG. 36C).

As shown in FIG. 36D, the metal-free covalent organic-inorganic hybrid polymer shows a second SHG response close to KDP (a classic and commercial NLO material). The high SHG response of single-crystal metal-free covalent organic-inorganic hybrid polymer can be attributed to the backbone (—Te—O—B—O—), resulting from the combination of 3-connected nods (BO₃) and 2-connected organic linkers (Te(Ph)₂).

### INDUSTRIAL APPLICABILITY

The invention prepared a serial of tellurium-based polymers and their single crystals and has successfully test the physical and chemical properties of these materials. Efficient methods to grow single-crystals for tellurium-based polymers are essential to get a solid understanding of the relationship between structure and properties, providing guidance for designing various tellurium-based covalent polymers to satisfy different requirements and applications. In addition, applied tellurium-based materials in optics and photocatalysis can offer the possibility of commercial and economic value.

### Definition

Throughout this specification, unless the context requires otherwise, the word “comprise” or variations such as “comprises” or “comprising”, will be understood to imply the inclusion of a stated integer or group of integers but not the exclusion of any other integer or group of integers. It is also noted that in this disclosure and particularly in the claims and/or paragraphs, terms such as “comprises”, “comprised”, “comprising” and the like can have the meaning attributed to it in U.S. Patent law; e.g., they allow for elements not explicitly recited, but exclude elements that are found in the prior art or that affect a basic or novel characteristic of the present invention.

Furthermore, throughout the specification and claims, unless the context requires otherwise, the word “include” or variations such as “includes” or “including”, will be understood to imply the inclusion of a stated integer or group of integers but not the exclusion of any other integer or group of integers.

References in the specification to “one embodiment”, “an embodiment”, “an example embodiment”, etc., indicate that the embodiment described can include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

As used herein, terms “approximately”, “basically”, “substantially”, and “about” are used for describing and explaining a small variation. When being used in combination with an event or circumstance, the term may refer to a case in which the event or circumstance occurs precisely, and a case in which the event or circumstance occurs approximately. As used herein with respect to a given value or range, the term “about” generally means in the range of 10%, ±5%, ±1%, or ±0.5% of the given value or range. The range may be indicated herein as from one endpoint to another endpoint or between two endpoints. Unless otherwise specified, all the ranges disclosed in the present disclosure include endpoints. When reference is made to “substantially” the same numerical value or characteristic, the term may refer to a value within ±10%, 5%, ±1%, or ±0.5% of the average of the values.

In the methods of preparation described herein, the steps can be carried out in any order without departing from the principles of the invention, except when a temporal or operational sequence is explicitly recited. Recitation in a claim to the effect that first a step is performed, and then several other steps are subsequently performed, shall be taken to mean that the first step is performed before any of the other steps, but the other steps can be performed in any suitable sequence, unless a sequence is further recited within the other steps. For example, claim elements that recite “Step A, Step B, Step C, Step D, and Step E” shall be construed to mean step A is carried out first, step E is carried out last, and steps B, C, and D can be carried out in any sequence between steps A and E, and that the sequence still falls within the literal scope of the claimed process. A given step or sub-set of steps can also be repeated. Furthermore, specified steps can be carried out concurrently unless explicit claim language recites that they be carried out separately.

The term “Spin-Orbit Coupling (SOC)” refers to interaction between a particle's spin and its motion, enhancing properties such as room-temperature phosphorescence.

The term “Nonlinear optical (NLO) materials” refers to Materials that exhibit a nonlinear response to optical fields, used in advanced photonics and optics.

The term “helical pitch” refers to the distance between two consecutive turns of the helical structure in the polymer.

Other definitions for selected terms used herein may be found within the detailed description of the present invention and apply throughout. Unless otherwise defined, all other technical terms used herein have the same meaning as commonly understood to one of ordinary skill in the art to which the present invention belongs.

What is claimed is:

1. A metal-free helical covalent organic polymer, comprising a helical backbone formed from one or more tellurium atoms covalently bonded to organic phosphonic acid groups, the one or more tellurium atoms form a repeating unit that contributes to a helical structure,
wherein the metal-free helical covalent organic polymer exhibits a metal-free composition and a three-dimensional or two-dimensional network arrangement, and
wherein the metal-free helical covalent organic polymer exhibits a thermal stability at a temperature of at least 300° C.

2. The metal-free helical covalent organic polymer of claim 1, wherein the organic phosphonic acid groups are selected from the group consisting of 1,4-phenylenebis(phosphonic acid), naphthalene-2,6-diylbis(phosphonic acid), and benzene-1,3,5-triyltris(phosphonic acid).

3. The metal-free helical covalent organic polymer of claim 1, wherein the metal-free helical covalent organic polymer has a helical pitch of less than 10 nm.

4. The metal-free helical covalent organic polymer of claim 1, wherein the metal-free helical covalent organic polymer displays photocatalytic activity in oxidation of primary amines to imines under UV-visible light irradiation.

5. The metal-free helical covalent organic polymer of claim 1, wherein the metal-free helical covalent organic polymer forms single crystals with sizes greater than 200 μm.

6. The metal-free helical covalent organic polymer of claim 1, wherein the repeating unit is represented by a structural formula comprising —Te—O—P(═O)— or —Te—O—P— bonds.

7. The metal-free helical covalent organic polymer of claim 6, wherein the —Te—O—P— bonds are formed by incorporating the one or more tellurium atoms and [P═O] groups into the backbone.

8. The metal-free helical covalent organic polymer of claim 1, wherein covalent linkages between the one or more tellurium atoms and the organic phosphonic acid groups result in enhanced structural stability.

9. The metal-free helical covalent organic polymer of claim 1, wherein the one or more tellurium atoms improve charge separation during photocatalytic processes, leading to an enhancement in overall photocatalytic performance by at least 25% to 40% compared to conventional polymers.

10. A metal-free helical covalent inorganic polymer represented by the formula {[Te(C₆H₅)₂][PO₃(OH)]}ₙ, comprising a helical structure formed from angular anions incorporated into tellurium-oxygen chains, and phenyl units as side groups,
wherein n indicates it is a polymer structure, and wherein the metal-free helical covalent inorganic polymer exhibits thermal stability up to 356° C. with minimal weight loss.

11. The metal-free helical covalent inorganic polymer of claim 10, wherein the helical structure exhibits a pitch of approximately 17.03 Å.

12. The metal-free helical covalent inorganic polymer of claim 10, wherein the angular anions are phosphates (PO₄³⁻) and/or their derivatives.

13. The metal-free helical covalent inorganic polymer of claim 10, wherein neighboring helical chains are interconnected by hydrogen bonding interactions, forming a pseudo-two-dimensional supramolecular layer structure.

14. The metal-free helical covalent inorganic polymer of claim 13, wherein adjacent helical layers exhibit opposite chirality, resulting in a racemic mixture.

15. A metal-free covalent organic-inorganic hybrid framework, comprising a chiral cubic crystalline structure formed from non-carbon backbones, wherein the chiral cubic crystalline structure comprises a —Te—O—B—O— backbone composed of:
tellurium (Te) atoms forming a backbone, wherein the Te atoms are linked by one or more covalent bonds,
boron (B) atoms incorporated as nodes within the metal-free covalent organic-inorganic hybrid framework in a form of borate groups, and
oxygen (O) atoms facilitating the formation of Te—O and B—O bonds,
wherein the metal-free covalent organic-inorganic hybrid framework exhibits UV absorption in a range of 200-300 nm, and
wherein the metal-free covalent organic-inorganic hybrid framework exhibits a thermal stability with a decomposition temperature of at least 310° C. considering a 5% weight loss.

16. The metal-free covalent organic-inorganic hybrid framework of claim 15, wherein the Te atoms are present in a form of tellurinyldibenzene (Te(Ph)₂) units.

17. The metal-free covalent organic-inorganic hybrid framework of claim 15, wherein the metal-free covalent organic-inorganic hybrid framework exhibits stability when exposed to various solvents and heat.

18. The metal-free covalent organic-inorganic hybrid framework of claim 15, wherein the framework consists of single crystals with dimensions of up to 400 μm.

19. The metal-free covalent organic-inorganic hybrid framework of claim 15, wherein the metal-free covalent organic-inorganic hybrid framework demonstrates a second harmonic generation (SHG) response comparable to that of potassium dihydrogen phosphate (KDP).
